(19) United States
(12) Patent Application Publication
(10) Pub. No.: US 2005/0083428 A1
(43) Pub. Date: Apr. 21, 2005

(54) IMAGE PICKUP APPARATUS

(76) Inventor: HIROTO OHKAWARA, IBARAKI-KEN (JP)

Correspondence Address: JOHN J. TORRENTE;COWAN, LIEBOWITZ & LATMAN, 1133 AVENUE OF THE AMERICAS, NEW YORK, NY, 10036-6799, US

(21) Appl. No.: 08/615,494

(22) Filed: Mar. 12, 1996

(30) Foreign Application Priority Data
Mar. 17, 1995 (JP) HEI 07-058908
Mar. 27, 1995 (JP) HEI 07-068362

(51) Int. Cl. H04N 5/232; G03B 3/00; G03B 13/18; G03B 13/32; G03B 13/00

(52) U.S. Cl. 348/345; 396/89

(57) ABSTRACT

An image pickup apparatus comprises a sharpness extracting circuit for generating a sharpness signal corresponding to a degree of focus from a video signal generated by photoelectric conversion of a subject image inputted via a focus adjusting lens group, a state-of-focus determining circuit for determining whether the focus adjusting lens group is in focus, on the basis of the sharpness signal, a focusing circuit for performing a focusing operation to move the focus adjusting lens group along an optical axis, and a focusing restarting circuit for restarting the focusing operation of the focusing circuit when a parameter obtained when the focus adjusting lens group is in focus and a current parameter differ from each other. Since AF control and program-mode control are controlled in an interlocked manner, it is possible to effectively prevent defocusing which occurs if these controls are independently performed.

### BACKGROUND OF THE INVENTION

1. Field of the Invention

The present invention relates to an image pickup apparatus and, more particularly, to an arrangement suitable for use in an image pickup apparatus having an automatic focus adjusting device for automatically bringing a subject image into focus.

2. Description of the Related Art

It has heretofore been known that an image pickup apparatus, such as a video camera, having a two-dimensional image pickup element makes use of a method of detecting the sharpness of a picture from a video signal generated by photoelectric conversion of a subject image and controlling the position of a focusing lens so that the sharpness becomes a maximum, and bringing the subject image into focus.

To evaluate the sharpness, it is general practice to use the strength of a high-frequency component of a video signal extracted by a band-pass filter or the detection strength of a defocusing width of a video signal extracted by a differentiating circuit or the like. In a case where an image of a subject is picked up, if the focusing lens is out of focus, the level of such a strength signal is small, but as the focusing lens approaches an in-focus point, the level of the strength signal becomes larger. If the focusing lens completely reaches the in-focus point, the level of the strength signal reaches a maximum.

Accordingly, if such a sharpness signal is small, the focusing lens is driven at as high a speed as possible in the direction in which the sharpness signal becomes greater, and as the sharpness signal becomes greater, the driving speed of the focusing lens is made lower so that the focusing lens is precisely stopped on “the top of a hill” and brought into focus. Such an autofocus (AF) method is generally called a hill-climbing autofocus system (hereinafter referred to as “hill-climbing AF”).

The hill-climbing AF system has recently become popular in latest video cameras which are reduced in size and weight, because the hill-climbing AF system makes it possible to realize an autofocus (AF) mechanism by using a simple system.

In addition, some video cameras which have recently been provided as “human-friendly cameras” are equipped with program modes for realizing optimum states of image pickup according to individual image pickup modes.

The arrangement and the operation of a previously proposed video camera equipped with program modes will be described below reference to a block diagram of FIG. 1. In the following description, by way of example, reference will be made to a program AE in which program modes are applied to an exposure system for a video signal.

The arrangement of the camera signal processing system shown in FIG. 1 includes a lens group 401 for forming an image of light reflected from a subject, an iris mechanism 103, such as an iris, for controlling the amount of entering light, and an IG meter 118 for driving the iris mechanism 103. The IG meter 118 has, in its inside, iris detecting means, such as a Hall element, for detecting the state of the iris mechanism 103.

The arrangement shown in FIG. 1 also includes an IG driver 117 for driving the IG meter 118, and an image pickup element 106 for photoelectrically converting an entering optical image of the subject.

An image pickup element driving circuit 116 is provided for controlling the image pickup element 106 and reading a photoelectrically converted signal from the image pickup element 106, and for controlling the function of controlling a signal storage time, i.e., a so-called electronic-shutter function.

The arrangement shown in FIG. 1 also includes an automatic gain control (hereinafter referred to as the AGC circuit) 107 for electrically amplifying the photoelectrically converted signal read from the image pickup element 106, and a camera signal processing circuit 108 for applying signal processing, such as gamma correction, color separation and color-difference matrix, to the signal outputted from the AGC circuit 107 and adding a synchronizing signal to the processed signal to generate a standard TV signal (video signal).

The arrangement shown in FIG. 1 also includes an LCD display circuit 109, a liquid crystal display (LCD) 110, and a video tape recorder (hereinafter referred to as the VTR) 111 for recording on a recording medium (video tape) the video signal outputted from the camera signal processing circuit 108.

The arrangement shown in FIG. 1 also includes an exposure control circuit 114 which has an AE detecting circuit 114d for gating the output signal of the AGC circuit 107, as required, and performing light measurement for exposure compensation, such as center-weighted light measurement.

The exposure control circuit 114 also has an iris control part for controlling the iris mechanism 103 on the basis of the signal supplied from the AE detecting circuit 114d, an electronic-shutter control part for controlling the shutter speed of an electronic shutter controlled by the image pickup element driving circuit 116, and an AGC control part for controlling the gain and the like of the AGC circuit 107.

The arrangement shown in FIG. 1 also includes a gate pulse control circuit 403 for generating a gate pulse for gating the image area required for detection in the AE detecting circuit 114d.

The arrangement shown in FIG. 1 also includes a program mode selecting switch unit 123 for selecting one of the program modes, and a control microcomputer 402 for controlling the program modes.

The control microcomputer 402 sends a signal to an exposure control computing part 114c of the exposure control circuit 114, and changes settings such as AGC gain, shutter speed and aperture.

The exposure control computing part 114c determines whether the state of exposure of a video signal after the setting is a desired state, and the control microcomputer 202 obtains the result of this decision from the exposure control computing part 114c and performs loop control so that the state of exposure becomes an optimum state of exposure under image-pickup circumstances.

To enable optimum image pickup under various circumstances, the image pickup apparatus arranged in the above-described manner supposes several representative image pickup circumstances and is able to carry out an image pickup method called “program mode”. The program mode includes modes for controlling a plurality of parameters, such as gamma correction, aperture correction and color suppression correction, i.e., an exposure control parameter, a white balance control parameter and a camera signal processing parameter, under optimum conditions for the respective image pickup circumstances.

One example of the program mode in which exposure control is weighted will be described below.

Control parameters for determining exposure are an iris mechanism, an AGC, an electronic shutter and the like, and each of the control parameters is set as data for each program mode according to various subjects and image-pickup circumstances and the data are stored in the control microcomputer 402 as look-up tables. The control microcomputer 402 is provided with a look-up table LUT1 for a first program mode, a look-up table LUT2 for a second program mode, a look-up table LUT3 for a third program mode and a look-up table LUT4 for a fourth program mode.

In addition, the control microcomputer 402 is arranged to read the data of a look-up table corresponding to a program mode which is set through the program mode selecting switch unit 123, and performs control of each of the parameters on the basis of the read data, thereby performing the program mode.

For example, if the motion of a subject is fast, a so-called “SPORTS MODE” which makes it possible to pick up an image of superior moving-image resolution is enabled by preferentially setting the electronic shutter for controlling the storage time of the image pickup element 106 to a high speed. In addition, if the iris mechanism is preferentially made fully open and exposure control is performed with another parameter, the depth of field becomes shallow so that the effect of defocusing a background can be obtained, i.e., a so-called “PORTRAIT MODE” suited to picking up an image of a person or the like is enabled. Thus, it is possible to realize optimum image pickup under various image-pickup circumstances.

In addition, in the AE detecting circuit 114d of the exposure control circuit 114, it is possible to realize more optimum image pickup by controlling the distribution of light measurement on the basis of the setting of a detection area or a detection position which is set by the gate pulse control circuit 403 for the purpose of detecting a video signal for exposure control.

For example, as shown in FIG. 2(a), by detecting video signals from the entire image area and performing exposure control so that the detected signals can be fixed at a predetermined level, it is possible to perform so-called average light measurement. In addition, as shown in FIG. 2(b), by detecting video signals from only a central portion of the image area and performing exposure control so that the detected signals can be fixed at a predetermined level, it is possible to perform so-called center-weighted light measurement.

In addition, it is possible to perform exposure control which is a combination of the average light measurement and the center-weighted light measurement, by causing weighting circuits 114a and 114b to weight the data which are respectively detected from the entire image area and from the central portion of the image by the AE detecting circuit 114d, adding the weighted data together at a predetermined ratio to prepare the sum of the weighted data, and performing exposure control on the basis of the sum of the weighted data.

In addition, by changing the settings of the weighting ratios of the respective data for each of the program modes according to various subjects and image-pickup circumstances, it is possible to realize more optimum exposure control which utilizes the merits of the respective light measurement methods. For example, in the case of a scene in which a main subject is illuminated with a spotlight and surrounding subjects are dark or in the case of a backlit scene, if the amount of weighting of the center-weighted light measurement is increased to adjust the ratio of the center-weighted light measurement to the average light measurement, it is possible to perform well-balanced correct exposure control on not only the main subject but also the surrounding subjects such as a background.

If the entire picture is divided into areas, as shown in FIG. 2(c), and video signals are detected from the respective areas, it is possible to achieve fine exposure control by restricting areas in which to detect data for use in exposure control in each of the program modes or varying the weights of the respective areas, according to various subjects or image-pickup circumstances.

However, in the above-described example, since AF control and program-mode control are independently performed, the following problems arise.

For example, during AF control, if the state of the program mode varies and the iris is made fully open during an in-focus state, the depth of field becomes shallow. At this time, if a zoom position is set to a wide-angle side or the luminance of a subject is high, a level difference in AF evaluation signal level in many cases is not detected before and after the variation of the program mode. At this time, since the AF control is not restarted and remains stopped, the subject may be out of focus because of the shallowness of the depth of field.

If the state of the program mode varies during AF control using the hill-climbing method, the state of exposure of the iris, the electronic shutter, the automatic gain control circuit or the like varies and an AF evaluation signal fluctuates correspondingly. As a result, a focusing lens may be moved in an erroneous direction of hill climbing in which the subject will be out of focus, or it may be erroneously determined that the subject is in focus, and the focusing lens may be stopped in an out-of-focus state.

### SUMMARY OF THE INVENTION

In the light of the above-described problems, an object of the present invention is to prevent occurrence of drawbacks which may be encountered if AF control and program-mode control are independently performed.

Another object of the present invention is to realize a video camera which is arranged so that not only particular functions, such as AF and AE, but also the entire video camera can cope with any photographing condition.

To achieve the above objects, in accordance with one aspect of the present invention, there is provided a video camera which comprises sharpness extracting means for generating a sharpness signal corresponding to a degree of focus from a video signal generated by photoelectric conversion of a subject image inputted via a focus adjusting lens group, state-of-focus determining means for determining whether the subject image is in focus, on the basis of the sharpness signal outputted from the sharpness extracting means, focusing means for performing a focusing operation to move the focus adjusting lens group along an optical axis according to a decision result provided by the state-of-focus determining means and bringing the subject image into focus, and focusing restarting means for restarting the focusing operation of the focusing means according to a detection result obtained by detecting whether a parameter obtained when the subject image is in focus and a current parameter differ from each other.

In accordance with another aspect of the present invention, there is provided a video camera which comprises focus controlling means for controlling an operation of driving means for moving a lens group for performing focus adjustment, in parallel with an optical axis, image pickup mode selecting means for selecting one or more image pickup modes which are arbitrarily selectively usable according to image pickup conditions, state-of-image-pickup controlling means for performing control to provide an optimum state of image pickup for each of the one or more image pickup modes selected by the image pickup mode selecting means, and focusing restarting means for controlling the focusing controlling means and the state-of-image-pickup controlling means in an interlocking manner, the focusing restarting means being arranged to restart the focus controlling means according to a status of variation of the one or more image pickup modes.

In accordance with another aspect of the present invention, there is provided a video camera which comprises a lens group for performing focus adjustment, lens group driving means for moving the lens group in parallel with an optical axis, sharpness extracting means for extracting a sharpness signal corresponding to a degree of focus from a video signal generated by photoelectric conversion of a subject image inputted via the lens group, focusing means for performing focus adjustment on the basis of the sharpness signal extracted by the sharpness extracting means, image pickup mode selecting means for selecting one or more image pickup modes which are arbitrarily selectively usable according to image pickup conditions, state-of-image-pickup controlling means for performing control to provide an optimum state of image pickup for each of the one or more image pickup modes selected by the image pickup mode selecting means, and focusing restarting means for forcedly restarting the lens group when a state of image pickup is varied by control of the state-of-image-pickup controlling means.

In accordance with another aspect of the present invention, there is provided a video camera in which if a parameter obtained when the state of focus becomes an in-focus state and the current parameter differ from each other, since the focusing operation of the focusing means is restarted, occurrence of drawbacks which may be encountered if AF control and program-mode control are independently performed is effectively prevented, so that an AF control mechanism is securely restarted when the state of a program mode varies during an in-focus state or when the state of a program mode varies during hill-climbing AF control.

The above and other objects, features and advantages of the present invention will become apparent from the following detailed description of preferred embodiments of the present invention, taken in conjunction with the accompanying drawings.

### BRIEF DESCRIPTION OF THE DRAWINGS

FIG. 1 is a block diagram showing one example of an image pickup apparatus which precedes the present invention;

FIGS. 2(a) to 2(c) are views aiding in describing different light measurement areas;

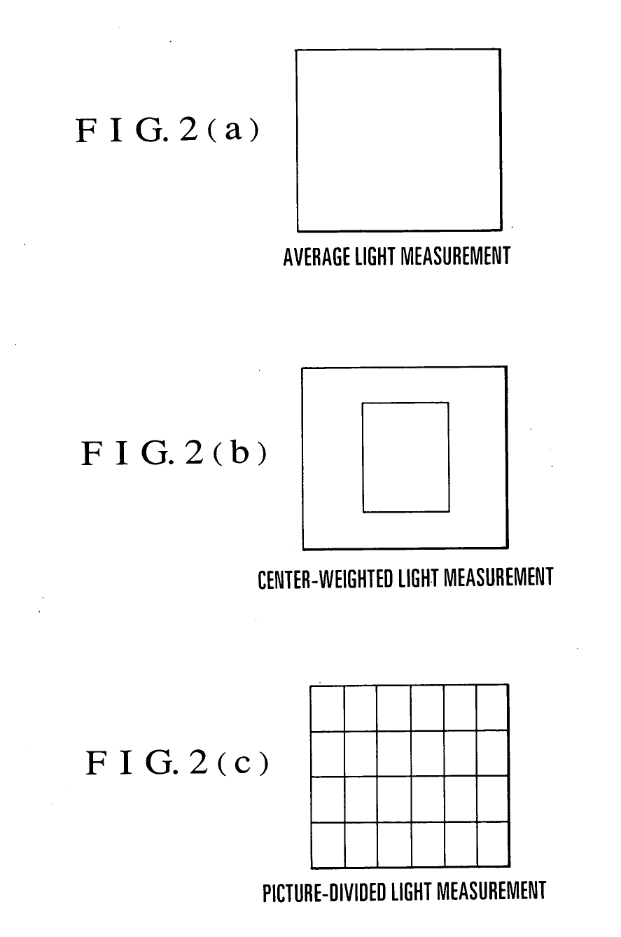

FIG. 3 is a schematic block diagram aiding in describing the essential-constituent elements of the present invention;

FIG. 4 is a block diagram of an image pickup apparatus, showing a first embodiment of the present invention;

FIG. 5 is a flowchart aiding in describing the operation of the first embodiment;

FIG. 6 is a flowchart aiding in describing the operation of a second embodiment;

FIG. 7 is a flowchart aiding in describing the operation of a third embodiment;

FIG. 8 is a schematic view showing the arrangement of a general inner focus type of lens system;

FIG. 9 is a block diagram showing an arrangement in which a lens control device according to a fourth embodiment of the present invention is applied to a video camera;

FIGS. 10(a) to 10(d) are views aiding in describing the construction and the operation of a volume encoder;

FIG. 11 is a flowchart aiding in describing the construction and the operation of the volume encoder;

FIG. 12 is a flowchart aiding in describing the construction and the operation of the volume encoder;

FIG. 13 is a flowchart aiding in describing the operation of the fourth embodiment of the invention;

FIGS. 14(a) and 14(b) are schematic views aiding in describing the construction and the operation of a comb rotary type of encoder which is fitted in a lens barrel; and

FIG. 15 is a flowchart aiding in describing the operation of a fifth embodiment of the present invention.

### DETAILED DESCRIPTION OF THE PREFERRED EMBODIMENTS

Preferred embodiments of an image pickup apparatus according to the present invention will be described below with reference to the accompanying drawings by using several examples in which the image pickup apparatus according to the present invention is applied to different video cameras.

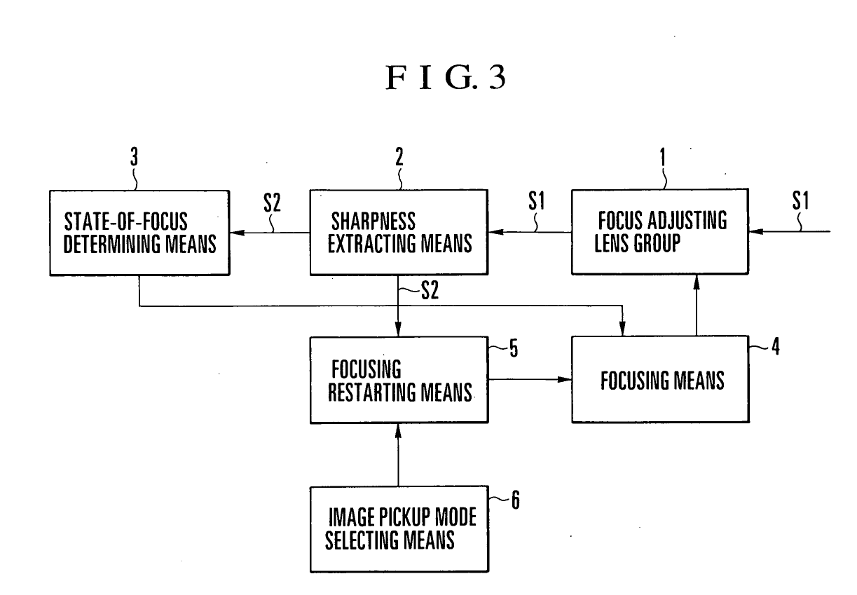

FIG. 3 is a functional block diagram aiding in describing the gist of the image pickup apparatus according to the present invention. As shown in FIG. 3, the image pickup apparatus includes a focus adjusting lens group 1, sharpness extracting means 2, state-of-focus determining means 3, focusing means 4, focusing restarting means 5, and image pickup mode selecting means 6.

The focus adjusting lens group 1 is provided for introducing reflected light S1 from a subject into the image pickup apparatus and focusing the reflected light S1 on a surface of an image pickup element (not shown).

The sharpness extracting means 2 is provided for generating a sharpness signal S2 from a video signal formed from the reflected light S1 from the subject which is inputted through the focus adjusting lens group 1, and is arranged to generate the sharpness signal S2 according to the degree of focus.

The state-of-focus determining means 3 is provided for determining whether the state of focus is an in-focus state, on the basis of the sharpness signal S2 which is outputted from the sharpness extracting means 2. Although the detailed contents of this decision will be described later, a hill-climbing method is employed to determine whether the state of focus is an in-focus state, according to whether the level of the sharpness signal S2 has exceeded its peak. Incidentally, in the present embodiments, whether the state of focus is an in-focus state is determined, and if the state of focus is not an in-focus state, it is determined whether the state of focus is a near-focus state or a far-focus state.

The focusing means 4 is provided for moving the focus adjusting lens group 1 along an optical axis so that the level of the sharpness signal S2 reaches the peak, according to the decision result provided by the state-of-focus determining means 3.

The focusing restarting means 5 is provided for detecting whether a parameter obtained when an in-focus state is achieved by the focusing means 4 has varied, and, if the parameter has varied, causing the focusing means 4 to again perform a focusing operation. This parameter is set for each image pickup mode and varies according to a change of the image pickup modes, and a variation of this parameter indicates a switchover from one of the image pickup modes to another, i.e., a change of program modes.

As one example for detecting such variation of the parameter, the focusing restarting means 5 of the present embodiment is arranged to detect a change of program modes. The detection of the change of the program modes is performed by starting an operating mode selected by the image pickup mode selecting means 6.

As another example for detecting the variation of the parameter, a level difference between the current AF evaluation value level and an in-focus AF evaluation value level is detected. The detection of the level difference is performed by storing the in-focus AF evaluation value level in a memory and comparing this stored level with the current AF evaluation value level.

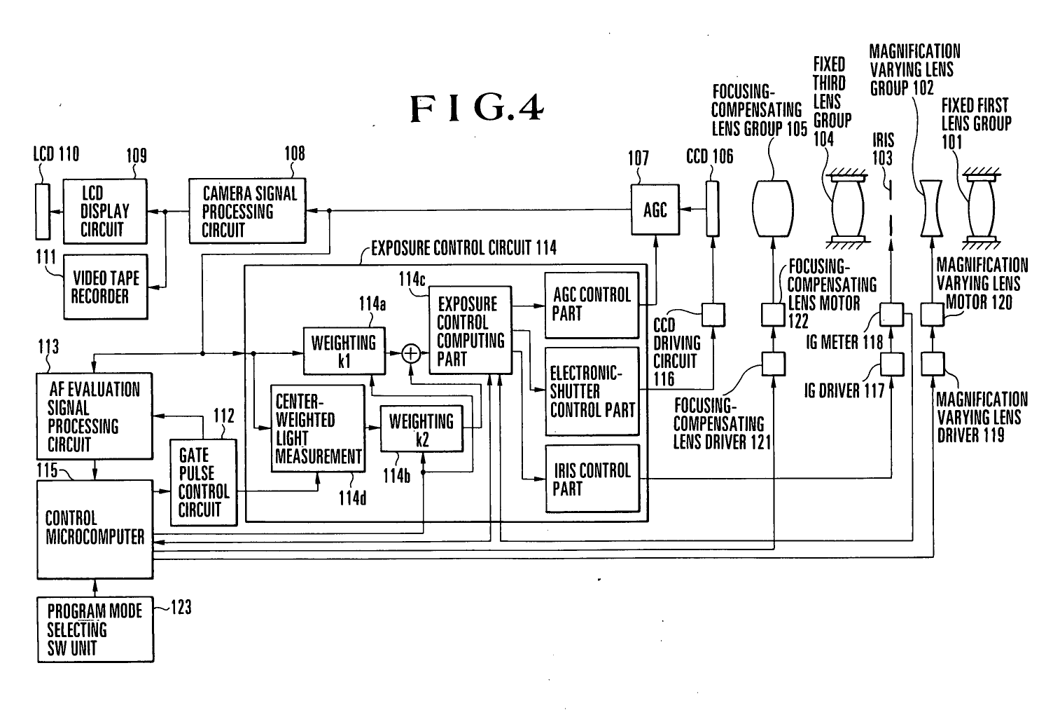

The specific constructions and the operations of first to third embodiments of the image pickup apparatus according to the present invention will be described below with reference to FIGS. 4 to 7.

FIG. 4 is a block diagram showing the specific construction of the first embodiment of the image pickup apparatus according to the present invention.

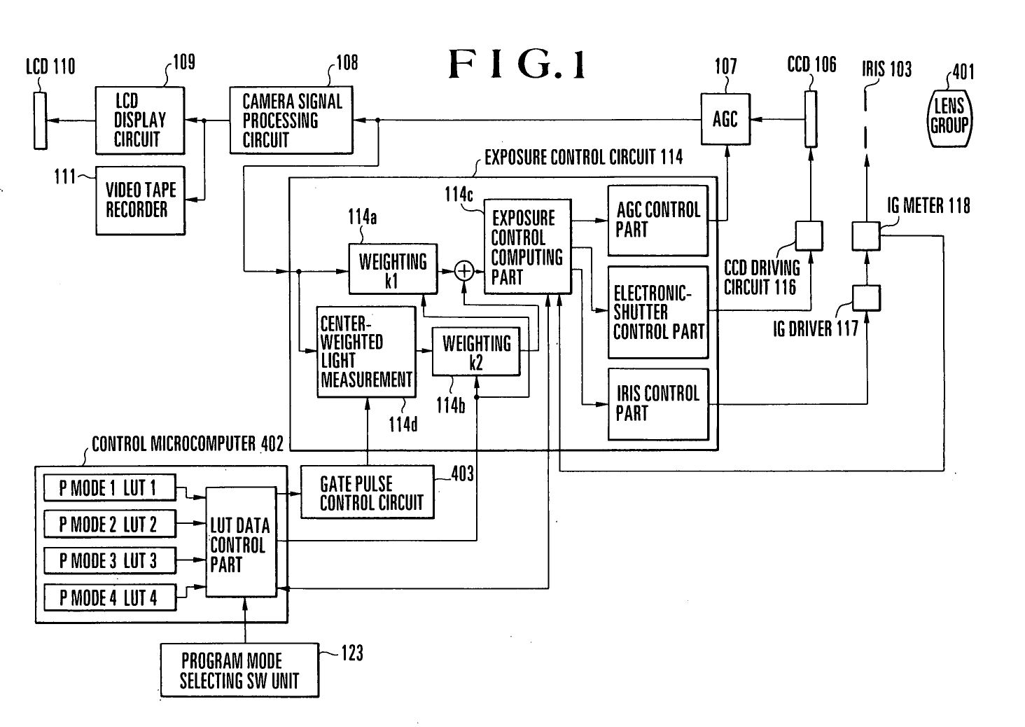

As shown in FIG. 4, in the first embodiment which will be described below, the present invention is used in a VTR-integrated camera. In FIG. 4, identical reference numerals are used to denote constituent elements identical to those shown in FIG. 1. In the following description of the features of the present embodiment, the detailed description of constituent elements which do not particularly relate to the present invention is omitted for the sake of simplicity.

The construction shown in FIG. 4 includes a fixed first lens group 101 which constitutes a front lens group, a second lens group 102 which is provided for varying magnification, an iris 103, a fixed third lens group 104, and a fourth lens group 104 which serves both a compensating function and a focusing function. These constituent elements 101 to 105 constitute an inner focus type of lens system.

Image light from a subject passes through this lens system and is focused on a surface of an image pickup element 106, and the image formed on the surface is converted into a video signal by photoelectric conversion. The video signal is applied to an AGC circuit 107, in which the applied video signal is controlled to make its level equal to a predetermined signal level.

The signal outputted from the AGC circuit 107 is applied to a camera signal processing circuit 108. If the image pickup element 106 is, for example, a color image pickup element which uses a complementary color checkered filter, the camera signal processing circuit 108 performs predetermined kinds of processing, such as filtering processing for eliminating color components to extract a luminance component, filtering processing for correcting the frequency characteristics of an optical system, gamma correction, delay and selection processing for obtaining a picked-up image output through the complementary color checkered filter, matrix processing for obtaining RGB data, and matrix processing for generating color-difference data from the RGB data.

The video signal processed in the camera signal processing circuit 108 is sent to a video tape recorder 111 as a television signal and also to an LCD display circuit 109. The video signal is subjected to predetermined processing in the LCD display circuit 109, and is displayed on the display screen of a liquid crystal display device (LCD) 110. The video signal amplified by the AGC circuit 107 is also sent to an exposure control circuit 114 and an AF evaluation signal processing circuit 113.

As described in detail previously in the section “Description of the Related Art”, the exposure control circuit 114 includes a center-weighted light measuring circuit for sampling only the predetermined portion of the video signal that is set by a gate pulse control circuit 112, and performs adjustment of the amount of light by driving an IG driver 117 and an IG meter 118 and controlling the iris 103 according to the input level of the video signal outputted from the AGC circuit 107, and also performs electronic-shutter control and control of the AGC circuit 107 via an image pickup element driving circuit 116.

The AF evaluation signal processing circuit 113 is provided for generating a signal for focus evaluation from the output signal of the AGC circuit 107. To generate an evaluation signal, the AF evaluation signal processing circuit 113 is provided with a gate circuit and a filter for sampling only the predetermined portion of the video signal that is set by the gate pulse control circuit 112.

A control microcomputer 115 is provided for executing focus adjustment based on the output signal of the AF evaluation signal processing circuit 113, focus compensation during variation of magnification, control of the exposure control circuit 114, and control of the gate pulse control circuit 112 for determining a gate area for focus adjustment and that for light measurement.

The program stored in the control microcomputer 115 constitutes control means and state-of-image-pickup controlling means.

Similarly to the control microcomputer 402 shown in FIG. 1, the control microcomputer 115 has a plurality of look-up tables in its inside and performs control of each program mode. Incidentally, although in the following description of the first embodiment exposure control program modes are referred to by way of example, the operation of each of the exposure control program modes is similar to that described in detail previously in the section “Description of the Related Art”.

The gate pulse control circuit 112 defines a gate area which is required to input particular video information from a picked-up-image picture into the AF evaluation signal processing circuit 113 or the exposure control circuit 114 according to the output from the control microcomputer 115, and then outputs a gate pulse to the AF evaluation signal processing circuit 113 or the exposure control circuit 114.

A selecting switch unit 123 is provided for changing the program modes from one mode to another.

A magnification varying lens driver 119 and a focusing-compensating lens driver 121 are provided for outputting driving energy (driving current) to the corresponding lens driving motors according to driving instructions which are respectively outputted from the control microcomputer 115 for driving the magnification varying lens group 102 and the focusing-compensating lens group 105. A magnification varying lens motor 120 and a focusing-compensating lens motor 122 are respectively provided as lens group driving means for driving the magnification varying lens group 102 and that for driving the focusing-compensating lens group 105.

If the magnification varying lens motor 120 and the focusing-compensating lens motor 122 are stepping motors, lens driving is performed in the following manner.

The control microcomputer 115 sends to the motor driver 119 a rotation frequency signal for controlling the frequency of rotation of the magnification varying lens motor 120 according to a speed at which to move the motor 120 and a rotation direction signal for controlling the direction of rotation of the magnification varying lens motor 120 according to a direction in which to drive the magnification varying lens motor 120. The control microcomputer 115 also sends similar signals to the motor driver 121.

Each of the motor drivers 119 and 121 controls the direction and the frequency of rotation of the corresponding one of the stepping motors 120 and 122 by setting the phase order of four motor excitation phases to a phase order for forward rotation or a phase order for reverse rotation according to the received rotation direction signal and by outputting voltages (or currents) for the respective four motor excitation phases to the corresponding motor while varying the voltages (or the currents). Thus, the stepping motors 120 and 122 are respectively rotated to drive the magnification varying lens group 102 and the focusing-compensating lens group 105.

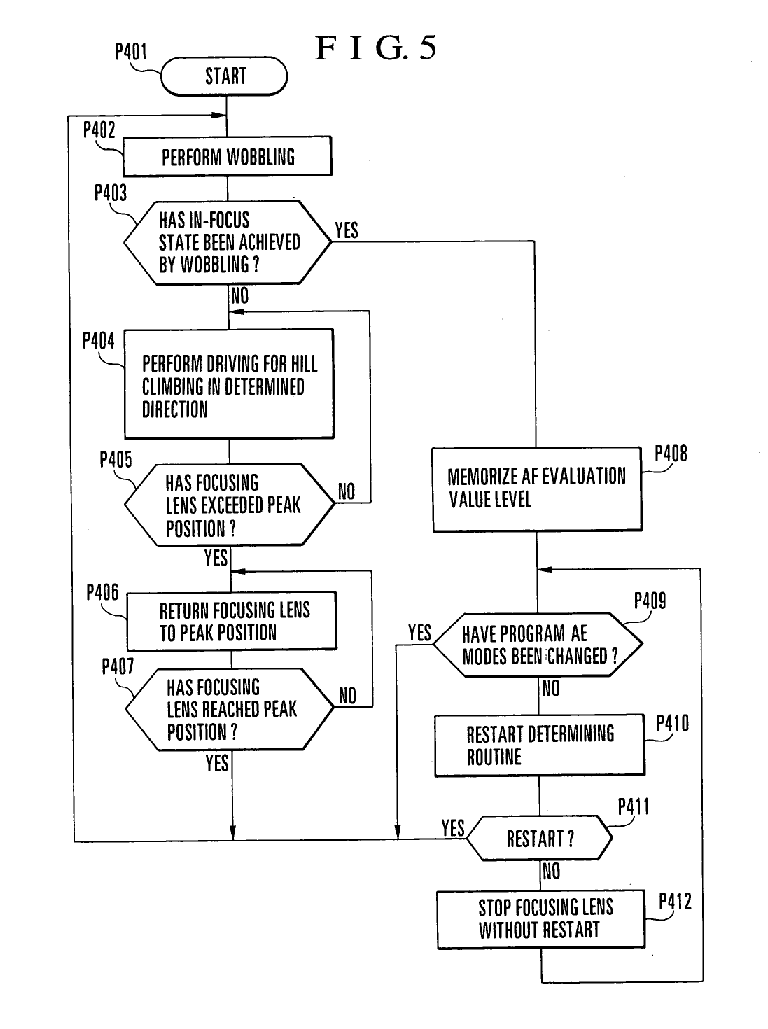

FIG. 5 is a control flowchart aiding in describing the operation of the image pickup apparatus according to the present invention. In the following description, reference will be made to program AE for exposure control by way of example. Although the processing of the flowchart of FIG. 5 is performed by the control microcomputer 115, the control microcomputer 115 executes the aforesaid program mode AE control separately from the processing shown in FIG. 5.

Step P401 indicates the start of the process. When the process is started, a wobbling operation is performed in Step P402. The wobbling operation is the operation of driving the focusing-compensating lens group 105 (hereinafter referred to simply as the focusing lens 105) by a small amount via focus controlling means.

In the following steps, the control microcomputer 115 obtains an AF evaluation value while driving the focusing lens 105 by a small amount, and determines whether the state of focus is an in-focus state or an out-of-focus state. If the state of focus is an out-of-focus state, the control microcomputer 115 determines whether the out-of-focus state is a near-focus state or a far-focus state.

The process proceeds to Step P403, in which it is determined whether an in-focus state has been achieved by the wobbling operation performed in Step P402. If it is determined that the in-focus state has been achieved, the process proceeds to Step P408, whereas if it is determined that the state of focus is an out-of-focus state, the process proceeds to Step P404.

In Step P404, driving for hill climbing in a determined direction is executed. This hill-climbing operation is performed by lens-group driving means. In Step P405, a decision is made as to the result of the execution of the hill-climbing operation. In Step P405, it is determined whether the focusing lens 105 has exceeded an in-focus point which corresponds to the peak of the AF evaluation signal, i.e, a peak position. If the focusing lens 105 has not yet exceeded the peak position, the process returns to Step P404, in which the driving for hill climbing in the determined direction is continued.

On the other hand, if it is determined that the focusing lens 105 has exceeded the peak position, the process proceeds to Step P406, in which the focusing lens 105 is moved back toward the peak position. In Step P407, it is determined whether the focusing lens 105 has reached the peak position. A focusing operation is performed by the loop of Steps P406 and P407 until the focusing lens 105 reaches the peak position.

While the operation of moving the focusing lens 105 back to the peak position is being performed by repeatedly performing the loop of Steps P406 and P407 in the above-described manner, the state of a subject may vary, as by panning. For this reason, when the focusing lens 105 reaches the peak position, the process returns to Step P402 and a wobbling operation is again performed to determine whether the current position of the focusing lens 105 is accurately the peak position, i.e., the in-focus point.

On the other hand, if it is determined in Step P403 that the in-focus state has been achieved, the process proceeds to a restart monitoring routine which starts from Step P408.

In the restart monitoring routine, first, in Step P408, the AF evaluation signal level obtained during the in-focus state is memorized.

Then, in Step P409, it is determined whether a change of the program AE modes has been made through the program mode selecting switch unit 123. For example, if a mode change to “PORTRAIT MODE” is made during the in-focus state, exposure control is performed so that the iris 103 is preferentially made fully open. In this case, since the depth of field is shallow, the subject may be out of focus.

It is, therefore, necessary to restart the driving of the focusing lens 105 and again confirm whether the in-focus state is maintained. If it is determined in Step P409 that a change of the program AE modes has been made, the process returns to Step P402 and the above-described operation is repeated. If it is determined in Step P409 that a change of the program AE modes has not been made, the process proceeds to Step P410.

Step P410 is a restart determining routine in which it is determined whether the current AF evaluation signal level has varied compared to the AF evaluation signal level memorized during the in-focus state in Step P408. For example, if the current AF evaluation signal level has varied by a predetermined percent with respect to the memorized level, it is determined that the state of the subject has changed, as by panning, and the driving of the focusing lens 105 needs to be restarted. If the amount of variation of the current AF evaluation signal level is less than the predetermined percent, it is determined that the state of the subject has not changed and the driving of the focusing lens 105 does not need to be restarted.

In Step P411, it is determined whether to restart the driving of the focusing lens 105, according to the result of the decision made in Step P410. If a restart of the driving of the focusing lens 105 is not needed, the process proceeds to Step P412, in which the focusing lens 105 is stopped at a position where it is located at that time. After that, the process returns to Step P409, in which the aforesaid restart monitoring operation is again performed to determine whether a restart is needed.

On the other hand, if it is determined in Step P411 that a restart of the driving of the focusing lens 105 is needed, the process returns to Step P402 and the wobbling operation is again performed to determine in which direction to move the focusing lens 105. By repeating such operation, the focusing lens 105 is driven so that the in-focus state is maintained at all times.

Accordingly, even if the state of focus becomes an out-of-focus state during a change of the program AE modes, it is possible to quickly recover the state of focus from the out-of-focus state by performing AF control by using the algorithm shown in FIG. 5.

A second embodiment of the image pickup apparatus according to the present invention will be described below. In the above description of the first embodiment, reference has been made to the example in which when a change of the program AE modes is detected through the state of the program mode selecting switch unit 123 during an in-focus state, a restart of the driving of the focusing lens 105 is immediately performed.

In the first embodiment, however, since loop control is performed in the exposure control of the image pickup apparatus, a predetermined period of time is generally required until the state of exposure of a video signal becomes stable after exposure settings have been changed.

Accordingly, in the case of the first embodiment, if the focusing lens 105 is driven when the state of exposure is not yet stable, since the AF evaluation signal is also unstable, it may become impossible to correctly determine in which direction to move the focusing lens 105 to bring it into focus.

The second embodiment is intended to solve the above-described problem, and includes means for forcedly inhibiting the movement of a focus adjusting lens group during a predetermined time interval even if a change of program modes is detected.

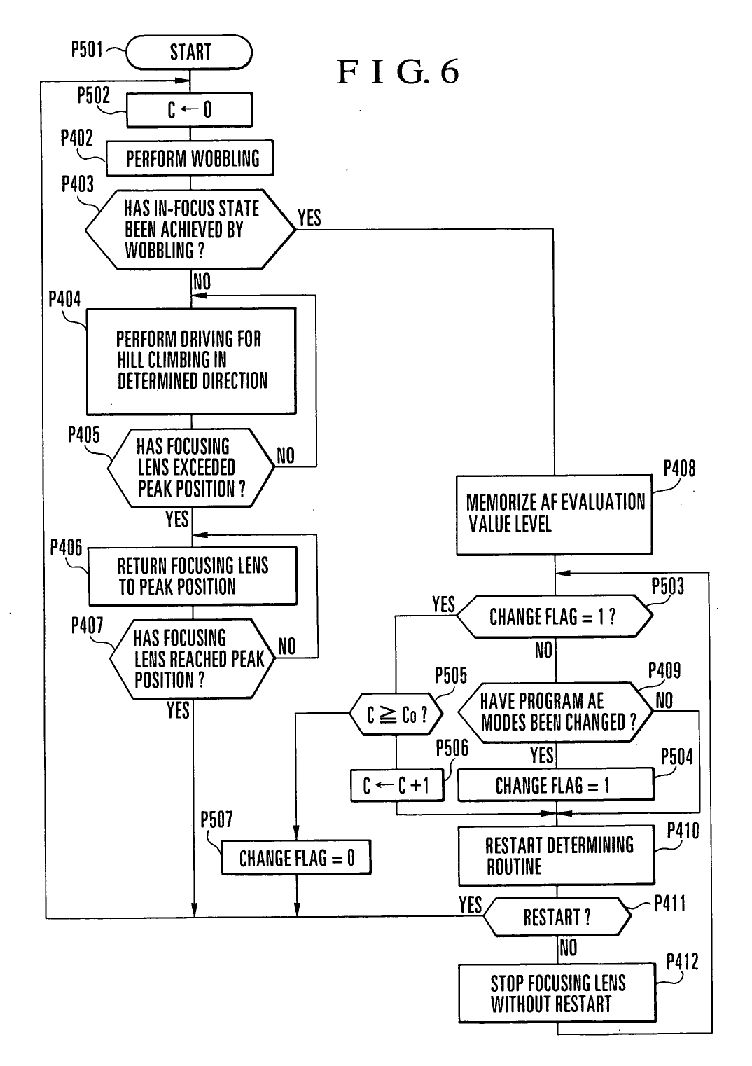

FIG. 6 is a control flowchart for carrying out the second embodiment, and identical reference numerals are used to denote steps having contents which are identical to those of the steps shown in FIG. 5.

Referring to FIG. 6, when the process is started in Step P501, a wait time counter C for counting the predetermined time interval during which a forced restart of the driving of the focusing lens 105 is inhibited is first cleared in Step P502.

Then, the process proceeds to Step P402 and then to Step P403. Through these steps, the control microcomputer 115 performs a wobbling operation and obtains an AF evaluation value while driving the focusing lens 105 by a small amount, and determines whether the state of focus is an in-focus state or an out-of-focus state (if the state of focus is an out-of-focus state, whether the out-of-focus state is a near-focus state or a far-focus state).

If it is determined that the in-focus state has been achieved, the process proceeds to Step P408, whereas if it is determined that the state of focus is an out-of-focus state, the process proceeds to Step P404. In Step P404, driving for hill climbing in a direction determined on the basis of the wobbling operation is executed.

Then, in Step P405, it is determined whether the focusing lens 105 has exceeded an in-focus point which corresponds to the peak of the AF evaluation signal, i.e, a peak position. If the focusing lens 105 has not yet exceeded the peak position, the process returns to Step P404, in which the driving for hill climbing in the determined direction is continued.

On the other hand, if it is determined in Step P405 that the focusing lens 105 has exceeded the peak position, the process proceeds to Step P406, in which the focusing lens 105 is controlled so that it is moved back toward the peak position. In Step P407, it is determined whether the focusing lens 105 has reached the peak position. The loop of Steps P406 and P407 is repeated until the focusing lens 105 reaches the peak position.

While the operation of moving the focusing lens 105 back to the peak position is being performed by repeatedly performing the loop of Steps P406 and P407 in the above-described manner, the state of a subject may vary, as by panning. For this reason, when the focusing lens 105 reaches the peak position, the process returns to Step P402 and a wobbling operation is again performed to determine whether the current position of the focusing lens 105 is accurately the peak position, i.e., the in-focus point.

On the other hand, if it is determined in Step P403 that the in-focus state has been achieved, the process proceeds to a restart monitoring routine which starts from Step P408. In this case, in Step P408, the AF evaluation signal level obtained during the in-focus state is memorized.

Then, in Step P503, it is determined whether a change flag has been set. This change flag is set when a change of the program AE modes is detected, and is cleared when a forced restart of the driving of the focusing lens 105 is executed after a wait of a predetermined time interval.

If it is determined in Step P503 that the change flag has been cleared, it is determined in Step P409 whether a change of the program AE modes has been made through the program mode selecting switch unit 123.

If the result of the decision made in Step P409 is true, the process proceeds to Step P504, in which the value of the change flag is set to “1”, and then proceeds to Step P410.

If the result of the decision made in Step P409 is false, the process proceeds to Step P410, in which monitoring processing for a normal restart is performed.

Step P410 is a restart determining routine in which it is determined whether the current AF evaluation signal level has varied compared to the AF evaluation signal level memorized during the in-focus state in Step P408. For example, if the current AF evaluation signal level has varied by the predetermined percent with respect to the memorized level, it is determined that the state of the subject has changed, as by panning, and the driving of the focusing lens 105 needs to be restarted. If the amount of variation of the current AF evaluation signal level is less than the predetermined percent, it is determined that the state of the subject has not changed and the driving of the focusing lens 105 does not need to be restarted.

In Step P411, it is determined whether to restart the driving of the focusing lens 105, according to the result of the decision made in Step P410. If a restart of the driving of the focusing lens 105 is not needed, the process proceeds to Step P412, in which the focusing lens 105 is stopped at a position where it is located at that time. After that, the process returns to Step P409, in which the aforesaid restart monitoring operation is again performed to determine whether a restart is needed.

On the other hand, if it is determined in Step P411 that a restart of the driving of the focusing lens 105 is needed, the process returns to Step P402 and the wobbling operation is again performed to determine in which direction to move the focusing lens 105. By repeating such operation, the focusing lens 105 is driven so that the in-focus state is maintained at all times.

If a change of the program AE modes has been made in Step P409 and the value of the change flag is set to “1” in Step P504 and it is determined in Step P410 that a restart of the driving of the focusing lens 105 is not needed, the process returns to Step P503. In this case, since the value of the change flag is “1”, the process proceeds to Step P505.

In Step P505, it is determined whether the count value of the wait time counter C is equal to or greater than a predetermined time value C₀. If C<C₀, the process proceeds to Step P506, in which the count value of the wait time counter C is incremented, and then proceeds to Step P410.

After that, if C≧C₀ is satisfied while the processing from Step P410 is being performed, the process proceeds from Step P505 to Step P507, in which the value of the change flag is set to “0”. After that, the process proceeds to Step P502, and the above-described restart operation is executed.

The predetermined time value C₀ is set to a value corresponding to the period of time which is taken from the moment when the program AE modes are changed from one mode to another through the program mode selecting switch unit 123 until the moment when the state of exposure becomes stable in an optimum state in the newly selected mode. Accordingly, if the result of the decision made in Step P505 is true, the AF evaluation value is stable so that it is possible to correctly determine in which direction an in-focus point is present, by performing the wobbling operation in Step S502.

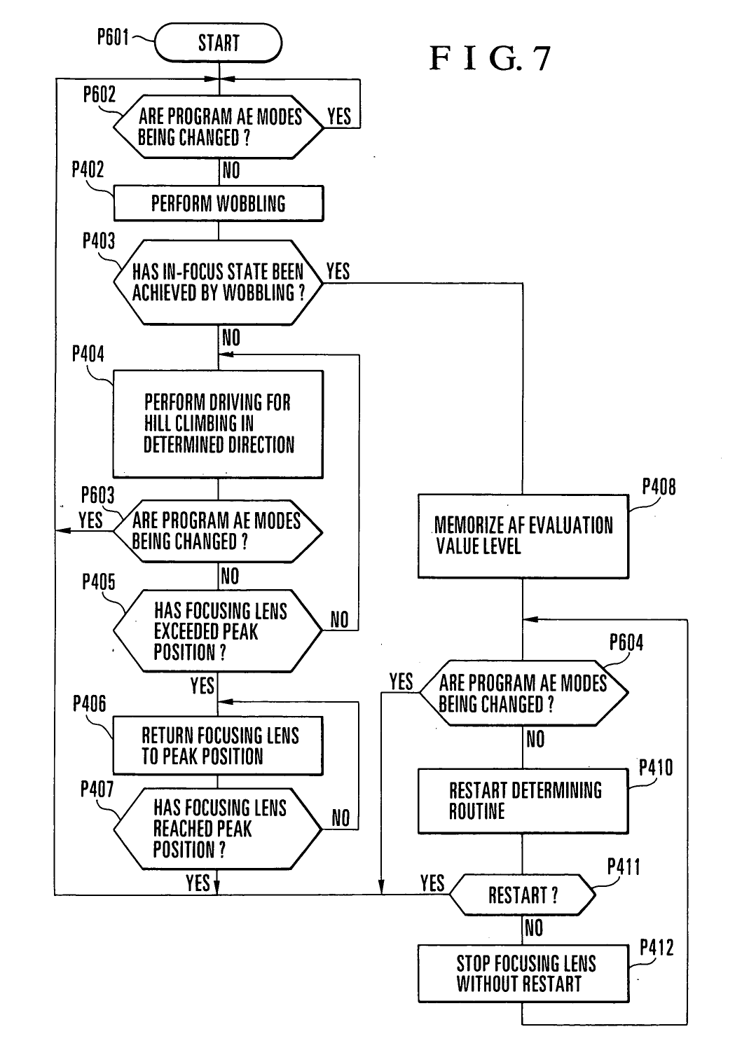

By performing AF control by using the algorithm shown in FIG. 7, it is possible to perform a forced restart operation during a change of the program AE modes and suppress a phenomenon in which an out-of-focus state is caused by making an erroneous decision as to a direction in which to move the focusing lens 105 to bring it into focus.

A third embodiment having such feature will be described below with reference to the flowchart shown in FIG. 7. In FIG. 7, identical reference numerals are used to denote steps having contents which are identical to those of the steps shown in FIGS. 5 and 6, and the description thereof is omitted for the sake of simplicity.

When the process is started in Step P601, it is determined in Step P602 whether a change of the program AE modes is being made. If it is determined that a change of the program AE modes is being made, the process waits until the change is completed. If the change is completed, the process proceeds to Step P402.

The processing of Steps P402 to P404 is similar to that described previously in connection with each of the first and second embodiments.

In the third embodiment, in Step P603 which follows Step P404, it is determined whether a change of the program AE modes is being made. After that, the processing of Steps P405 to P407 is performed similarly to the above-described embodiments.

Although in the above-described flowchart of FIG. 5 it is determined in Step P409 following Step P408 whether a change of the program AE modes has been made, in the third embodiment, it is determined in Step P604 following Step P408 whether a change of the program AE modes is being made.

In the third embodiment, as described above, since the forced restart operation is performed during a change of the program AE modes, it is possible to suppress the phenomenon in which an out-of-focus state is caused by making an erroneous decision as to a direction in which to move the focusing lens 105 to bring it into focus.

According to the above-described embodiments, since the AF control and the program-mode control are interlockingly performed, if a parameter obtained when the state of focus becomes an in-focus state and the current parameter differ from each other, the focusing operation of the focusing means is restarted, so that it is possible to prevent occurrence of drawbacks which may be encountered if the AF control and the program-mode control are independently performed.

Thus, it is possible to securely restart an AF control mechanism, for example, when a photographing mode is switched to vary the state of a program mode during an in-focus state or when the state of a program mode varies during hill-climbing AF control.

Accordingly, when an in-focus state is achieved by the AF control, even if the depth of field becomes shallow owing to a variation of the state of the program mode, it is possible to prevent occurrence of an out-of-focus state.

In addition, even if the state of exposure varies owing to a variation of the state of the program mode during AF control using the hill-climbing method, since a video signal obtained during the variation of the state of exposure is not used for the AF control, it is possible to prevent an erroneous decision from being made as to the direction of hill climbing or the state of focusing, so that it is possible to realize AF control which does not cause an out-of-focus state.

A fourth embodiment of the present invention will be described below. The fourth embodiment is an expanded version of each of the aforesaid embodiments, and is intended to prevent malfunctions from occurring while various kinds of photography are being performed in a video camera having both an automatic focusing function and a manual focusing function.

The following description is made in connection with the background of the fourth embodiment as well as the arrangement and operation thereof.

As described above, in an automatic focusing device for a video camera, to evaluate sharpness indicative of the state of focus detection, the following signal strengths are generally employed, such as the strength of a high-frequency component of a video signal extracted by a band-pass filter or the detection strength of a defocusing width of a video signal extracted by a differentiating circuit or the like.

In a case where an ordinary subject is photographed, if a focusing lens is out of focus, such a sharpness signal is small, but as the focusing lens approaches an in-focus point, the sharpness signal becomes larger. If the focusing lens is in best focus, the sharpness signal reaches a maximum.

Accordingly, if the sharpness signal is small, the focusing lens is driven at as high a speed as possible in the direction in which the sharpness signal becomes greater, and as the sharpness signal becomes greater, the driving speed of the focusing lens is made lower so that the focusing lens can be made to precisely stop on “the top of a hill”, i.e., so that the focusing lens can be brought into focus.

Such an autofocus method is generally called a hill-climbing autofocus system (hereinafter referred to as “hill-climbing AF”). This hill-climbing AF system has become popular as AF for video cameras, because the hill-climbing can use a lens system which is reduced in size and weight compared to an active AF system arranged to measure a subject distance by using infrared light or the like.

However, in the case of a scene in which a plurality of subjects are located at different distances and a contention between far focus and near focus is caused, the obtained sharpness signal will have different peaks for different subject distances. As a result, AF control alone may not be able to determine at which of the subject distances a subject aimed at by a photographer is located. In this case, the photographer needs to assist AF by using manual focusing means or the like.

For this reason, various techniques for manual focusing operation have been proposed so that manual focusing can be performed more readily and conveniently. One example is the function of making manual focusing active while a manual focusing member is being manipulated, even during an AF mode. Another example is the function of making one-shot AF active while a switch is pressed, even during a manual focusing mode.

Recently, as cameras have rapidly been reduced in size and weight, lens systems for realizing the aforesaid functions have also been reduced in size at a remarkable rate. One typical example is the changeover from a front-lens focus type to an inner focus type, and, particularly in the field of video cameras, products using inner focus types of lens systems have become popular.

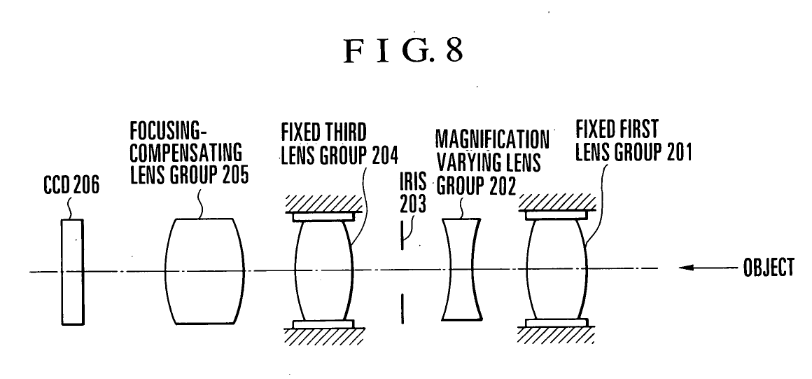

One example of such an inner focus type of lens system is shown in FIG. 8.

The lens system shown in FIG. 8 includes a fixed first lens group 201, a second lens group 202 for performing variation of magnification by moving in parallel with the optical axis, an iris 203, a fixed third lens group 204, a fourth lens group 205 having the focusing-compensating function of performing focusing by moving in parallel with the optical axis and of preventing a movement of a focal plane due to variation of magnification by performing a compensation operation according to a movement of the second lens group 202, and an image pickup device 206.

In the inner focus type of lens system shown in FIG. 8, since the fourth lens group 205 has a small size and a light weight, a drive transmission system can be made small and simple by using a stepping motor as an actuator.

Since step pulses to be supplied to the stepping motor can readily be generated in a lens control microcomputer, it is possible to accurately detect the position of the focusing lens 205 by counting the number of step pulses outputted from the lens control microcomputer itself without especially providing an encoder for detection of the position of the focusing lens 205.

In the case of a mechanism which is generally used in the front-lens focus type of lens system, i.e., a mechanism arranged to effect focusing by rotating a distance ring mechanically fitted on a lens barrel and moving a focusing lens mechanically connected to the distance ring, since the focusing lens moves in proportion to the amount of rotation of the distance ring, it is advantageously possible to realize smooth focusing over the entire range of focusing operations from rough focus adjustment to fine focus adjustment.

However, in the inner focus type of lens system in which all movable lenses are disposed in a lens barrel, it is difficult to mechanically couple a distance ring to the focusing lens so that the focusing lens can be moved by external force. The primary reasons for this are that if the focusing lens is rotated via a cam ring or the like mechanically coupled to the focusing lens, without using a control circuit, an error occurs between the count value of the number of driving pulses supplied to the stepping motors and an actual position of the focusing lens, and that the drive transmission system of simple structure has a structure which is not suited to a mechanical manual operation.

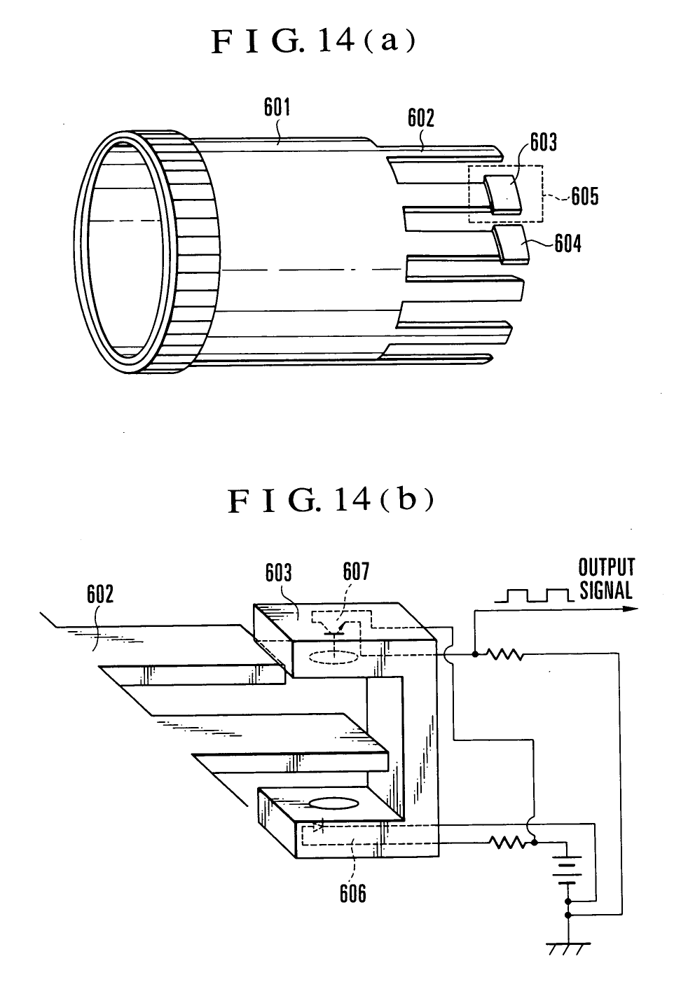

To cope with the above disadvantages, several kinds of video cameras using the inner focus type of lens system have an encoder of the type shown in FIGS. 14(a) and 14(b) (to be described later) which is fitted in a lens barrel, and adopts a method of electrically detecting the direction and the speed of rotation of the encoder and moving the focusing lens according to the detected direction and speed.

However, in the inner focus type of lens system, if the method of electrically detecting the amount of manipulation of the distance ring through the encoder (volume) or the like in the above-described manner is adopted and manual focusing operation is designed so that it can smoothly respond to the rotation of the volume whether the volume is rotated at high speeds or at low speeds, the rotation of the volume will be detected with high response even when a photographer mistakenly touches the volume during AF mode, with the result that the focusing lens may be unnecessarily moved to induce unnecessary defocusing.

In general, the intention of a photographer who is rotating the volume during AF is to assist AF by rapidly moving a focus in a target direction rather than to perform fine adjustment of an out-of-focus subject. In the case of the manual focusing mode, the photographer will rotate the volume in order to smoothly and finely focus a target subject. Accordingly, if the amount of movement of the focusing lens is constant per predetermined angle of rotation of the volume, the photographer will have to rotate the volume over and again for the purpose of moving the focus during AF, or will not be able to perform subtle adjustment of focus during MF (manual focusing).

The present embodiment is intended to provide a lens control device of good operability and reliability in which even if a photographer mistakenly touches a manual operating volume during an AF operation, a focusing lens is prevented from being unnecessarily moved to induce unnecessary defocusing.

To achieve the above object, in accordance with the present embodiment, there is provided a video camera which comprises an optical system the focus of which can be adjusted (the focusing lens 205 in the present embodiment), automatic focus controlling means for detecting a state of focus of the optical system and performing automatic focus adjustment (an AF evaluation value processing circuit 217 and an AF microcomputer 215 in the present embodiment), manipulating means for manipulating the optical system in an arbitrary direction (a focus volume unit 224 in the present embodiment), and controlling means for varying a response characteristic of the optical system relative to a manipulation of the manipulating means according to a state of operation of the automatic focus adjusting means (the AF microcomputer 215 and the processing of the flowchart shown in FIG. 14, in the present embodiment).

In accordance with another aspect of the present embodiment, there is provided a video camera in which the controlling means is arranged to enable the manipulation of the manipulating means even while the automatic focus adjusting means is operating, and to inhibit a movement of the optical system if the amount of manipulation of the manipulating means is not greater than a predetermined amount, while the automatic focus adjusting means is operating.

In accordance with another aspect of the present embodiment, there is provided a video camera in which the controlling means is arranged to enable the manipulation of the manipulating means even while the automatic focus adjusting means is operating, and to lower a response of the optical system relative to a variation of a state of manipulation of the manipulating means while the automatic focus adjusting means is operating.

In accordance with another aspect of the present embodiment, there is provided a video camera which comprises focus adjustment controlling means for automatically performing focus adjustment of an optical system, manipulating means for performing focus adjustment of the optical system in accordance with an external manipulation, detecting means for detecting a state of manipulation of the manipulating means, lens controlling means for varying a state of the optical system according to a variation of the state of manipulation of the manipulating means which is detected by the detecting means, and controlling means for varying a detection sensitivity of the detecting means according to an operational state of focus adjustment of the optical system.

In accordance with another aspect of the present embodiment, there is provided a video camera in which the controlling means is arranged to lower the detection sensitivity of the detecting means while the focus adjustment controlling means is operating.

In accordance with another aspect of the present invention, there is provided a video camera which comprises focus adjustment controlling means for automatically performing focus adjustment of an optical system, manipulating means for performing focus adjustment of the optical system in accordance with an external manipulation, detecting means for detecting a state of manipulation of the manipulating means, lens controlling means for varying a state of the optical system according to a variation of the state of manipulation of the manipulating means which is detected by the detecting means, and controlling means for varying a ratio of variation of the state of the optical system with respect to a ratio of variation of the state of manipulation of the manipulating means in the lens controlling means, according to an operational state of the focus adjustment controlling means.

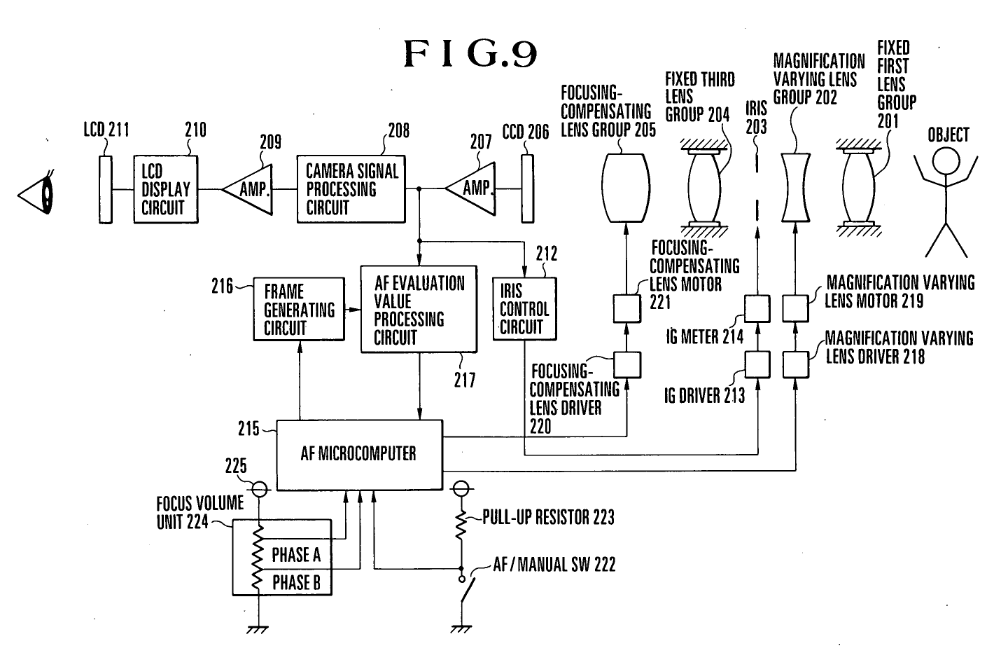

The fourth embodiment which serves as the lens control device will be described below with reference to FIGS. 9 to 14(a) and 14(b).

FIG. 9 is a block diagram showing the arrangement of the fourth embodiment. The arrangement shown in FIG. 9 includes an inner focus type of lens system which is composed of constituent elements, such as the fixed front lens group 201, the second lens group 202 for performing variation of magnification (hereinafter referred to as the magnification varying lens 202), the iris 203, the fixed third lens group 204 and the fourth lens group 205 having both a compensator function and a focusing function (hereinafter referred to as the focusing lens 205).

Light from a subject passes through this lens system and is focused on an image pickup surface of the image pickup element 206, and the image formed on the image pickup surface is converted into a video signal by photoelectric conversion. The arrangement shown in FIG. 9 also includes an amplifier or impedance converter 207 and a camera signal processing circuit 208. The video signal processed by the camera signal processing circuit 208 is amplified to a prescribed level by an amplifier 209, and an LCD display circuit 210 processes the output from the amplifier 209 and displays a photographed image on an LCD 211 which serves as an electronic viewfinder.

In the meantime, the video signal amplified by the amplifier 207 is sent to an iris control circuit 212 and the AF evaluation value processing circuit 217. The iris control circuit 212 drives an IG driver 213 and an IG meter 214 according to the input level of the video signal, thereby controlling the amount of opening of the iris 203 and adjusting the amount of light so that the level of the video signal is fixed at a predetermined level.

The AF evaluation value processing circuit 217 performs the processing of extracting, according to a gate signal supplied from a distance measuring frame generating circuit 216, only the high-frequency component of a video signal which is obtained inside a distance measuring frame which is set at a predetermined position in a picture, and detecting the state of focus.

The AF control microcomputer 215 (hereinafter referred to as the AF microcomputer 215) controls a direction in which and a speed at which to drive the focusing lens 205, according to an AF evaluation signal strength supplied from the AF evaluation value processing circuit 217. To change a distance measuring area, the AF microcomputer 215 transfers control of the distance measuring frame to the distance measuring frame generating circuit 216, thereby controlling the position, the size and the like of the distance measuring frame according to the state of focus or the kind of photographing mode.

The shown arrangement also includes an AF/MF selecting switch 222 for selecting an AF (automatic focusing) mode or an MF (manual focusing) mode and a pull-up resistor 223 for inputting the state of the AF/MF selecting switch 222 to the AF microcomputer 215.

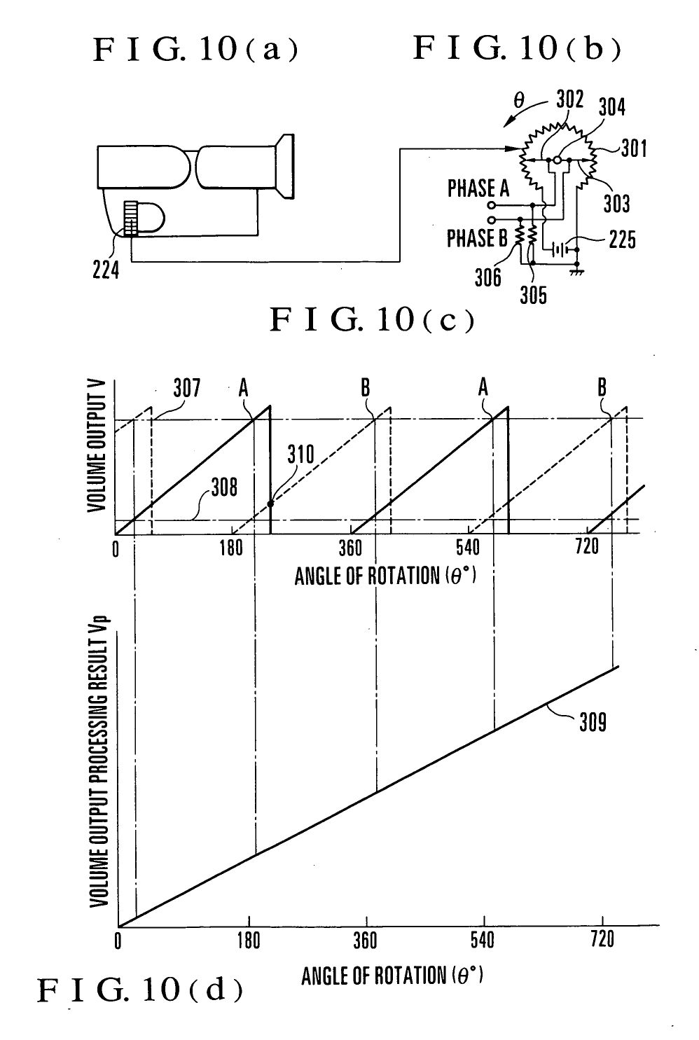

The shown arrangement also includes a power source 225 and the focus volume unit 224 for moving the focusing lens 205 in the manual focusing mode which will be described later with reference to FIGS. 10(a) and 10(b). Two output phases of the focus volume unit 224 are connected to the A/D converting ports of the AF microcomputer 215.

The shown arrangement also includes a magnification varying lens driver 218 for outputting driving energy to a magnification varying lens motor 219 for driving the magnification varying lens (the second lens group) 202, in accordance with a zoom driving instruction outputted from the AF microcomputer 215 according to the operation of a zooming button (not shown).

The shown arrangement also includes a focusing lens driver 220 for outputting driving energy to a focusing lens motor 221 for driving the focusing lens 205 which also serves as a compensator lens, in accordance with a focusing lens driving instruction outputted from the AF microcomputer 215.

The AF microcomputer 215 outputs to the focusing lens driver 220, if a zooming operation is selected, a driving instruction for driving the focusing lens 205 to correct a variation of the position of the focal plane due to a movement of the magnification varying lens 202, or, if the AF mode is selected, a driving instruction based on a focus evaluation value according to the state of focus detected by the AF evaluation value processing circuit 217, or, if the MF mode is selected, a driving instruction according to the amount of manipulation of the focus volume unit 224.

By way of example, a rotary type of encoder which is conceptually analogous to the focus volume unit, or distance ring, 224 which is manipulated during the manual focusing mode will be described below with reference to FIGS. 14(a) and 14(b).

FIGS. 14(a) and 14(b) show one example of the rotary type of encoder. As shown in FIG. 14(a), a rotary type of encoder 601 to be fitted into a lens barrel includes a comb-shaped structure 602 having portions for reflecting light and portions for allowing light to pass through them, a light emitting element 603 having a light emitting part 606, and a light receiving element 604 having a light receiving part 607. The states of the output signals from the respective elements 603 and 604 vary according to whether light reflected from the comb-shaped structure 602 is received. FIG. 14(b) is a magnified view of a portion 605 which is surrounded by dashed lines in FIG. 14(a).

When the encoder 601 is rotated, the output signals from the respective elements 603 and 604 vary. The positional relationship between the light emitting element 603 and the light receiving element 604 is determined so that the phases of the two output signals deviate from each other by an appropriate amount. The rotational speed of the encoder 601 is detected from the period of the variation of each of the output signals, and the rotational direction of the encoder 601 is detected from the phase relationship between the two signals.

The lens control device receives the output signals from the light emitting element 603 and the light receiving element 604, and determines a direction in which and a speed at which to drive the focusing lens 205. By providing the encoder shown in FIGS. 14(a) and 14(b), it is possible to realize manual focusing during which photographers can experience a sensation of manipulation similar to that experienced with a front-lens focus type of lens system in spite of an inner focus type of lens system.

An endless type of volume encoder may also be employed in place of the encoder shown in FIGS. 14(a) and 14(b). The endless type of volume encoder differs from the encoder shown in FIGS. 14(a) and 14(b) in that the encoder is not fitted into the lens barrel, but is equivalent in performance to and is more inexpensive than the encoder shown in FIGS. 14(a) and 14(b) in terms of an arrangement which moves a focusing lens in proportion to the amount of rotation and enables smooth focusing over the entire range of focusing operations from rough focus adjustment to fine focus adjustment.

FIGS. 10(a) and 10(b) are conceptual diagrams of the aforesaid endless type of volume encoder. It is assumed here that the fourth embodiment shown in FIG. 9 employs the endless type of volume encoder.

Referring to FIGS. 10(a) and 10(b), an endless type of volume encoder unit 224 includes a resistor 301, slide elements 302 and 303 which are secured in such a manner as to be opposed to each other at an angle of 180° and are arranged to individually rotate about an insulating element 304, and pull-down resistors 305 and 306.

FIG. 10(c) shows the manner of variation of the output signal of the focus volume unit 224 when the slide elements 302 and 303 rotate. The output terminals of the respective slide elements 302 and 303 correspond to a phase A and a phase B.

When the slide elements 302 and 303 rotate in the counterclockwise direction as viewed in FIG. 10(b) (in the direction in which an angle of rotation θ increases as viewed in FIG. 10(c)), the levels of the output signals of the phases A and B rise from zero to the +potential of the power source 225. If the slide element 302 or 303 starts sliding on a portion in which the resistor 301 is absent, the level of the output signal of the corresponding phase A or B returns to zero by the action of the corresponding pull-down resistor 305 or 306. Since the slide elements 302 and 303 are secured in such a manner as to be opposed to each other at an angle of 180°, the output waveforms of the phases A and B become 180° out of phase, i.e., equal to each other.

Contrarily, when the slide elements 302 and 303 rotate in the clockwise direction as viewed in FIG. 10(b) (in the direction in which the angle of rotation θ decreases as viewed in FIG. 10(c)), the level of the output signal of the phase A or B is at zero while the corresponding slide element 302 or 303 is sliding on the portion in which no resistor 301 is absent. However, when the slide element 302 or 303 comes into contact with the resistor 301, the corresponding output signal immediately exhibits the +potential of the power source 225. After that, the level of the output signal becomes gradually smaller and when the corresponding slide element 302 or 303 reaches the portion in which the resistor 301 is absent, the level of the output signal exhibits zero. The phase different between the output waveforms of the phases A and B is 180°.

In this manner, since the polarities of the slopes of the output signals of the respective slide elements vary according to the directions of rotation thereof and the amounts of inclination of the slopes vary according to the amounts of rotation of the respective slide elements, the lens control device can recognize the direction and the amount of rotation of the slide elements by detecting the polarities of the respective slopes and the amounts of inclination of the same. The lens control device controls the focusing lens 205 on the basis of this information.

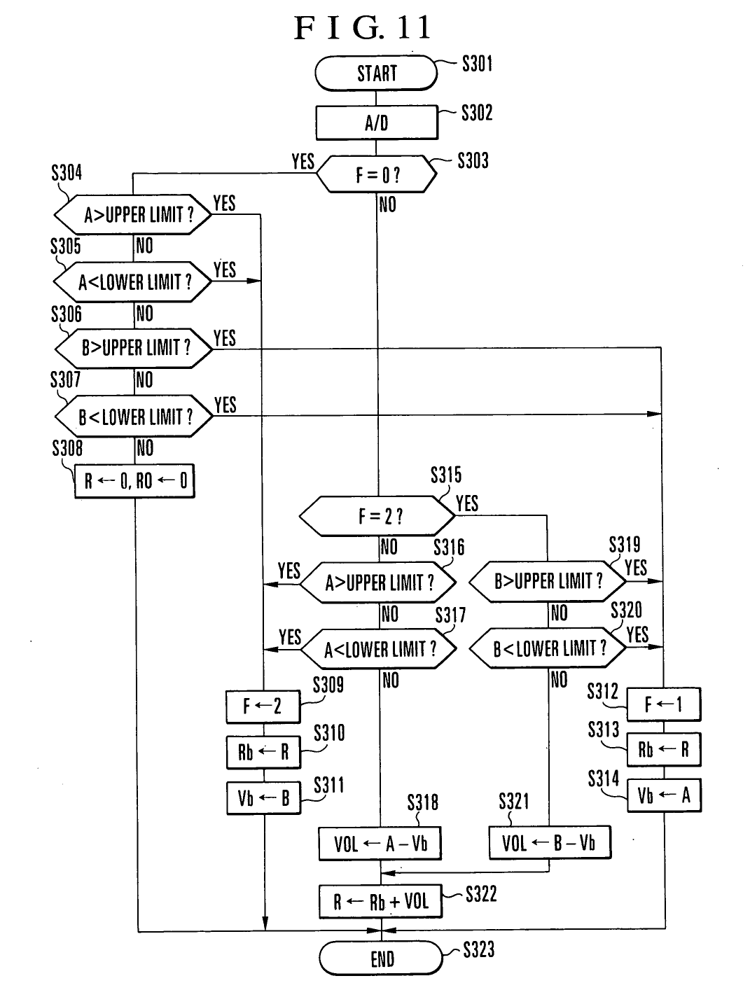

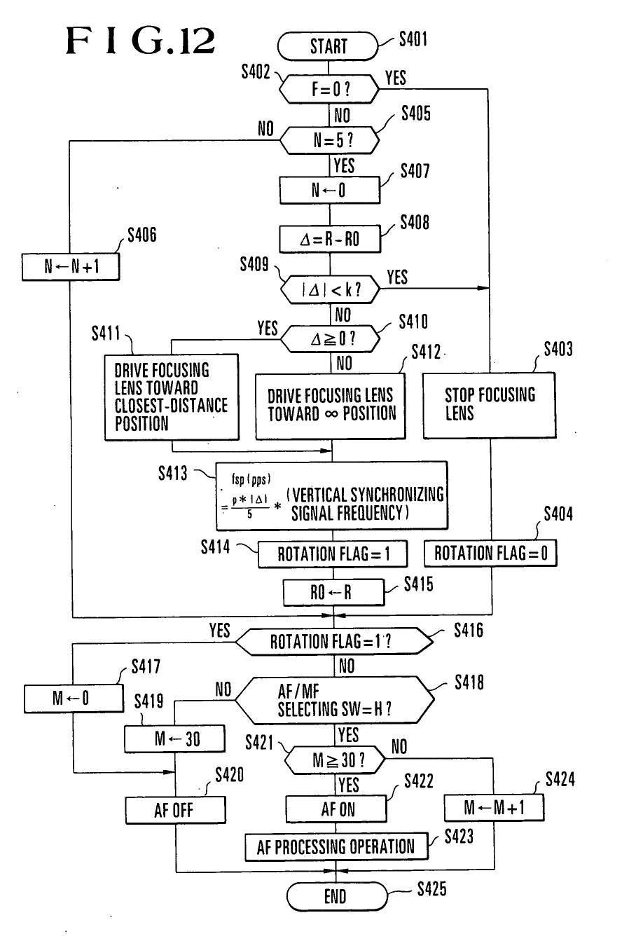

A focusing lens driving method using such an endless type of volume encoder will be described below with reference to FIGS. 11 and 12.

In this type of volume encoder, while each slide element is sliding on a portion in which a resistor is absent, the slide element provides an output signal which consists of discontinuous points.

For this reason, the processing shown in FIG. 11 is performed. In the processing shown in FIG. 11, if it is detected that the output signal of either of two slide elements is discontinuous, sampling is switched from that output signal to the output signal of the other slide element and is executed in such a way as to avoid detection of discontinuous points, so that a locus, such as the locus 309 shown in FIG. 10(d) can be obtained. The processing is processed in a lens control microcomputer.

When the processing is started in Step S301, A/D conversion of the output voltages of the phases A and B is performed in Step S302. In Step S303, it is determined whether the value of a flag F is “0”. This flag F is set to “1” upon completion of initial setting.

For example, immediately after the power source of the system is turned on, it is necessary to perform the required initial setting, such as which of the phases A and B is to be read. If the value of the flag F is “0”, this indicates that no such initial setting is completed.

If it is determined in Step S303 that the value of the flag F is “0”, it is determined in Steps S304 and S305 that the output level of the phase A is intermediate between thresholds 307 and 308 of FIG. 10(c). If the output level of the phase A is greater than the threshold 307 or smaller than the threshold 308, the process proceeds to Step S309 in order to detect the state of rotation in the phase B.

If the output level of the phase A is intermediate between the thresholds 307 and 308, it is determined in Steps S306 and S307 whether the output level of the phase B is outside the thresholds 307 and 308. If it is determined that the output level of the phase B is outside the thresholds 307 and 308, the process proceeds to Step S312 in order to detect the state of rotation in the phase A.

If it is determined through Steps S304, S305, S306 and S307 that the output levels of both phases A and B are intermediate between the thresholds 307 and 308, it is impossible to identify an output terminal through which the state of rotation is to be detected. Therefore, in Step S308, a first memory R is cleared to zero, and a memory R0 which will be described later in detail with reference to FIG. 12 is also cleared to zero. Thus, the processing is brought to an end in Step S323.

If the output levels of both phases A and B are simultaneously intermediate between the thresholds 307 and 308, this indicates that the volume of the volume encoder is located at a position corresponding to an output level 310 of FIG. 10(c). As a result, if the volume output is at the output level 310 immediately after the power source is turned on, it is impossible to determine which of the phases A and B has reached this value 310 beyond the thresholds, i.e., which of the phases A and B contains discontinuous points.

For this reason, if the volume is located at the position corresponding to the output level 310 during an initial state, the process does not start detection of rotation and waits until a photographer rotates the volume to another position so that either phase can be identified. Even if the process waits in this manner, if the photographer rotates the volume by an extremely small angle, the output level of either slide element which contains the discontinuous points takes on a value outside the thresholds and, from this point of time, it is possible to detect the amount of rotation. Accordingly, no operability is impaired in practical use.

If it is determined that the value of flag F is “0” and the output level of the phase A is outside the thresholds 307 and 308, the value of the flag F is replaced with “2” in Step S309. The fact that the value of the flag F is “2” means that sampling of the phase B is needed. Then, in Step S310, the value of a memory Rb is replaced with the value of the memory R. Then, in Step S311, a level Vb of the output terminal of a phase to be selected (the phase B) by switching is memorized. Thus, the process is completed.

The process of FIG. 11 is periodically repeated. When the above-described processing associated with the initial state is completed and the process is again started from Step S301, it is determined in Step S303 that the value of the flag F is “2”, and the process proceeds to Step S315.

If it is determined in Step S315 that the value of the flag F is “2”, the process proceeds to Step S319 to check the output level of the phase B. It is determined in Steps S319 and S320 whether the output level of the phase B is intermediate between the thresholds 307 and 308 of FIG. 10(c). If the output level of the phase B is intermediate between the thresholds 307 and 308, the process proceeds to Step S321, in which a difference VOL between an output value B of the phase B which has presently been sampled in Step S302 and an output value Vb of the phase B which has been memorized in Step S311 during the switching between the output phases is taken.

This difference value VOL is added to the value Rb which has been stored in the first memory R during the switching, and the value of the first memory R is replaced with the result of the addition. When the process returns to Step S322 to Step S301, if the value of the flag F has not varied, Steps S309 and S320 are executed. If the output level of the phase B sampled in Step S302 is intermediate between the thresholds 307 and 308, the processing of Step S321 is performed and, in Step S322, the value of the first memory is rewritten.

The above-described processing is repeated, until the output level of the output terminal of the phase B exceeds either of the thresholds 307 and 308. If the output level of the output terminal of the phase B exceeds either of the thresholds 307 and 308, the process proceeds to Step S312 from Step S319 or S320, in which the value of the flag F is rewritten with “1”.

The fact that the value of the flag F is “1” means that sampling of the output of the phase A is needed. Since the switching from the phase B to the phase A is performed, the value of the memory Rb is replaced with the value of the memory R in Step S313 and the value A of a phase to be selected (the phase A) by switching to the value Vb is memorized. Thus, the process is completed in Step S323.

Then, when the process starts from Step S301, since it is determined in Step S303 that the value of the flag F is “1”, the process proceeds to Steps S315 and S316. In Steps S316, S317 and S318, processing similar to that performed on the phase B is performed. If it is determined that the output level of the phase A is outside the thresholds 307 and 308, the process proceeds to the sampling of the phase B.

As is apparent from the above description, if the relationship between the aforesaid thresholds 307 and 308 and the period of repetition of the process of FIG. 11 is determined on the basis of the maximum speed of rotation of the volume so as to use the output level of the same output terminal continuously two or more times for detecting the state of rotation and the process of FIG. 11 is executed, the value of the first memory R becomes a continuous function which increases or decreases according to the direction of rotation of the volume in proportion to the amount of rotation of the same, as shown by the locus 309 in FIG. 10(d).

FIG. 12 is a flowchart for detecting the amount and direction of rotation of the volume by the use of the data of the first memory R and determining the movement of the focusing lens 205 from the result of the detection. The process of FIG. 12 is performed after the process of FIG. 11 has been executed.

When the process starts in Step S401 of FIG. 12, it is determined in Step S402 whether the value of the flag F is “0”. If it is determined that the value of the flag F is “0”, since it is impossible to identify an output phase, as described previously, the process proceeds to Step S403, in which the focusing lens 205 is made to stop.

If it is determined in Step S404 that the volume is not rotating, the value of a rotation flag is set to “0” and the process proceeds to Step S416.

If it is not determined in Step S402 that the value of the flag F is “0”, the process proceeds to Step S405, in which it is determined whether the value of a counter N has reached a predetermined value (“5” in FIG. 12). After the process of FIG. 11 has been executed, the process of FIG. 12 is necessarily performed.

Accordingly, although the period of repetition of the process of FIG. 11 and the period of repetition of the process of FIG. 12 are equal to each other, if the condition of Step S405 is not satisfied, a calculation to increase or decrease the value of the first memory R is not performed. Since the value of the counter N is compared with “5”, a second sampling period is five times as long as a first sampling period.

If it is not determined in Step S405 that the value of the counter N has not reached the predetermined value, the value of the counter N is incremented in Step S406 and the process proceeds to Step S416.

After that, after the process of FIG. 11 is completed, the process of FIG. 12 is repeated from Step S401 until it is determined in Step S405 that the value of the counter N has reached the predetermined value.

Then, in Step S407, the value of the counter N is cleared to zero, and, in Step S408, a difference A between the value R stored in the first memory at that point of time and the value RO stored in the first memory one second sampling period before is calculated. In a case where the process is executed and first proceeds to Step S408, since the memories R and RO have been cleared to zero in Step S308 of FIG. 11, the difference Δ is “0”.

The memory R0, which is arranged to be rewritten for each of the second sampling periods, is provided for calculating how the value of the first memory R has varied for one sampling period.

Step S409 is a block for cutting the fluctuation of data due to noise or quantizing error, and it is possible to prevent malfunction due to noise or the like by appropriately selecting the value of a threshold k (for example, “2”). If it is calculated in Step S408 that |Δ|=0, the process proceeds from Step S403 to Step S404 and the focusing lens is not made to move.

If it is determined in Step S409 that |Δ| is greater than or equal to the threshold k, the sign of difference Δ is checked in Step S410. From the sign of the difference Δ, it is possible to determine whether the value of the first memory R has increased or decreased from the previous value, so that it is possible to detect the direction in which the volume is rotated.

In this embodiment, if the difference Δ is increasing, it is determined in Step S411 that the focusing lens should be driven toward its closest-distance position, whereas if the difference Δ is decreasing, it is determined in Step S412 that the focusing lens should be driven toward its ∞ position.

If the direction in which to drive the focusing lens is determined in Step S411 or S412, an amount in which to move the focusing lens according to the amount of rotation of the volume is calculated in Step S413.

Although a method of calculating the amount in which to drive the focusing lens may be arbitrarily set, in this embodiment, the first sampling period is synchronized with a vertical synchronizing period and the focusing lens is made to move by an amount proportional to the amount of rotation of the volume which varies for one vertical synchronizing period (the amount of variation of the data of the first memory).

In Step S413, a computing expression for determining an amount fsp [pps] in which to drive the focusing lens per unit time is as follows:
fsp[pps]=p*|Δ|/5*(vertical synchronizing signal frequency) (1)
In Expression (1), p represents the amount of increase in the amount of driving of the focusing lens per variation of 1 LSB of Δ, |Δ| is divided by 5 to calculate the amount of variation of Δ per vertical synchronizing period, and p*|Δ|/5 is multiplied by the vertical synchronizing signal frequency to obtain the amount in which to drive the focusing lens per unit time (the second sampling period is five times as long as the vertical synchronizing period).

In Step S414, it is determined that the volume is rotating, and the value of the rotation flag is set to “1”. In Step S415, the value of the memory R0 is replaced with the current value of the first memory R so that the value of the memory R0 can be compared with the value of the first memory R when the value of the counter N reaches “5”.

The process proceeds to Step S416 so that while the volume is rotating, a manual focusing operation can be executed even during the AF mode.

It is determined in Step S416 whether the volume is rotating. If it is determined that the volume is rotating, the value of a counter M is cleared to zero in Step S417 and the mode of operation is set to AF:OFF (Step S420). This process is brought to an end in Step S425 and the focusing lens is driven in the direction determined in Step S411 or S412. The counter M serves as a wait time counter for adding hysteresis when the mode of operation changes from AF:OFF to AF:ON, and is provided for preventing an AF operation from being performed during the rotation of the volume when a photographer nonuniformly rotates the volume.

If it is determined in Step S416 that the volume is not rotating, the state of the AF/MF selecting switch is checked in Step S418. If the state of the AF/MF selecting switch is the MF mode, it is determined that the volume is not rotating and the focusing lens does not need to move. Accordingly, the process proceeds to Step S419, in which the counter M is set to a predetermined value. In Step S420, the mode of operation is set to AF:OFF, and, in Step S425, the process is brought to an end.

If it is determined in Step S418 that the state of the AF/MF selecting switch is the AF mode, it is determined that the AF mode is currently active and the volume is not rotating. The process proceeds to Step S421, in which it is determined whether the value of the counter M is greater than or equal to the predetermined value (which is, in this embodiment, equivalent to a hysteresis of 0.5 seconds in the case of a camera of 30:NTSC).

If it is determined in Step S421 that the answer is false, the value of the counter M is incremented by one in Step S424, and the process is brought to an end in Step S425. If the process passes through Step S424, it indicates that the state of the AF/MF selecting switch was the AF mode and the volume was rotated within the past thirty first sampling periods, and the mode of operation of the focusing lens is AF:OFF by the processing of Step S420. To check whether the rotation of the volume is actually stopped at this time, the mode of operation is not set to AF:ON within a predetermined time even if the value of the rotation flag is cleared to zero.

If it is determined in Step S421 that the rotation of the volume is continuously stopped for the predetermined time, the mode of operation is set to AF:ON in Step S422, and, in Step S423, a hill-climbing operation is executed by an AF processing routine to drive the focusing lens.

As is apparent from the above description, by providing means for sampling memory contents which vary while directly reflecting the movement of the volume, with the second sampling period which is longer than the first sampling period, and detecting the amount and the direction of rotation of the volume, it is possible to securely detect the amount of rotation of the volume while eliminating the influence of noise, even if the volume is slowly rotated. Accordingly, it is possible to realize a manual focusing operation which smoothly responds to the rotation of the volume even if the volume is rotated at high speeds or low speeds.

Incidentally, it is preferable that the setting of the thresholds 307 and 308 be such that hysteresis is provided so that, as shown in FIG. 10(c) by way of example, if the output level of the phase A falls below the threshold 308 and the phase B is selected, the output level of the selected phase B is below the threshold 307, whereas if the output level of the phase A rises above the threshold 307 and the phase B is selected, the output level of the selected phase B is above the threshold 307. According to such setting, it is possible to prevent oscillation of switching control at a switching point.

In the above-described arrangement, however, even when the photographer mistakenly touches the volume during the AF mode, the rotation of the volume is detected with high response, with the result that unnecessary defocusing may be induced by the movement of the focusing lens.

In general, the intention of a photographer who is rotating the volume during AF is to assist AF by rapidly moving a focus in a target direction rather than to perform fine adjustment of an out-of-focus subject. In the case of the manual focusing mode, the photographer will rotate the volume in order to smoothly and finely focus a target subject. Accordingly, if the amount of movement of the focusing lens is constant per predetermined angle of rotation of the volume, the photographer will have to rotate the volume over and again for the purpose of moving the focus during AF, or will not be able to perform subtle adjustment of focus during MF.

The fourth embodiment is also intended to solve the above-described problem by improving the processing of the AF microcomputer 215. A unique arrangement of the fourth embodiment for solving the problem will be described below.

In the following description of a motor driving method, the magnification varying lens motor 219 and the focusing lens motor 221 are assumed to be stepping motors.

The AF microcomputer 215 determines the driving speed of the magnification varying lens motor 219 and that of the focusing lens motor 221 through the processing of the program, and sends the respective driving speeds to the magnification varying lens driver 218 for driving the magnification varying lens motor 219 and the focusing lens driver 220 for driving the focusing lens motor 221, as rotation frequency signals for the respective stepping motors.

The AF microcomputer 215 also send to the respective drivers 218 and 220 instructions for driving/stopping the motors 219 and 221 and instructions for specifying directions in which to rotate the motors 219 and 221. Each of the motor drivers 218 and 220 sets the phase order of four motor excitation phases to a phase order for forward rotation or a phase order for reverse rotation according to the rotation direction signal and outputs voltages (or currents) for the respective four motor excitation phases to the corresponding motor while varying the voltages (or the currents), according to the received rotation frequency signal, thereby controlling the direction in which and the frequency at which to rotate the corresponding one of the motors 219 and 221. Each of the motor drivers 218 and 220 also performs on/off control of the output of the voltage to the corresponding motor according to the driving/stopping instruction.

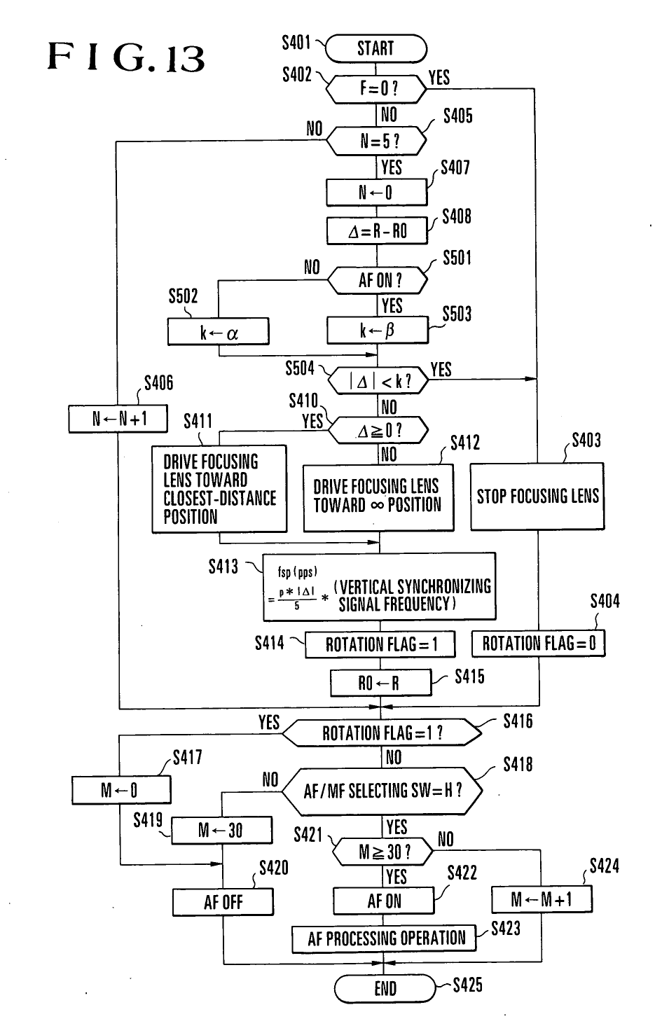

FIG. 13 is a flowchart of lens control processed in the AF microcomputer 215, showing a feature of the fourth embodiment.

The flowchart shown in FIG. 13 is a modified version of the above-described flowchart of FIG. 12 in that the feature of the fourth embodiment which will be described below is added to the flowchart of FIG. 12. In FIG. 13, identical reference numerals are used to denote steps having contents which are identical to those of the steps shown in FIG. 12.

The process shown in FIG. 13 performs the control of detecting the amount and the direction of rotation of the volume and determining an amount and a direction in which to drive the focusing lens, according to the detected amount and direction. It is assumed here that the process shown in FIG. 11 is necessarily executed before the process of FIG. 13 is performed, and that the processing result of the volume output shown in FIG. 10(d) is obtained.

When the process starts in Step S401 of FIG. 13, it is determined in Step S402 whether the value of the flag F is “0”. If it is determined that the value of the flag F is “0”, since it is impossible to identify an output phase, the process proceeds to Step S403, in which the focusing lens 205 is made to stop. Since it is determined that the volume is not rotating, the value of the rotation flag is set to “0” in Step S404 and the process proceeds to Step S416.

If it is not determined in Step S402 that the value of the flag F is “0”, the process proceeds to Step S405, in which it is determined whether the value of the counter N has reached a predetermined value (“5” in FIG. 13, which corresponds to a period which is five times the first sampling period mentioned previously in connection with FIG. 11. This five-times period is called “the second sampling period” in the following description as well). If it is not determined in Step S405 that the value of the counter N has reached the predetermined value, the value of the counter N is incremented in Step S406, and the process proceeds to Step S416.

After that, after the process of FIG. 11 is completed, the process of FIG. 13 is repeated from Step S401 until it is determined in Step S405 that the value of the counter N has reached the predetermined value.

Then, in Step S407, the value of the counter N is cleared to zero, and, in Step S408, the difference Δ between the value R stored in the first memory at that point of time and the value R0 stored in the first memory one second sampling period before is calculated. In a case where the process is executed and first proceeds to Step S408, since the memories R and R0 have been cleared to zero in Step S308 of FIG. 11, the difference Δ is “0”. The memory R0, which is arranged to be rewritten for each of the second sampling periods, is provided for calculating how the value of the first memory R has varied for one sampling period.

Then, in Step S501, it is determined whether the mode of focusing operation is currently set to AF:ON or AF:OFF.

If it is determined that the mode of focusing operation is AF:OFF, the value of the threshold memory k is replaced with a predetermined value α. If it is determined in Step S501 that the mode of focusing operation is AF:ON, the value of the threshold memory k is replaced with a predetermined value β.

It is determined in Step S504 whether |Δ| is greater than or equal to the value of the threshold memory k. If the result of this decision is false, it is determined that the volume is not rotating, and the process proceeds to Step S403 and the focusing lens is not made to move. If the result of the decision made in Step S504 is true, it is determined that the volume is rotating, and the process proceeds to Step S410.

In the processing of Steps S501 to S504, the dead zone of detection of the rotation of the volume is varied between AF:ON and AF:OFF to vary the sensitivity of detection of the rotation of the volume, so that even if the photographer mistakenly touches the volume during AF:ON, the focusing lens is prevented from malfunctioning, and only when the volume is substantially rotated, focusing can be performed.

To realize this operation, it is preferable that the predetermined values α and β which are respectively stored in the threshold memory k in Steps S502 and S503 be determined so that α<β is satisfied.

In addition, to realize subtle focus adjustment during manual focusing, it is necessary to prevent malfunction due to noise or the like by improving the resolution of detection of the rotation of the volume and cutting the fluctuation of data due to noise or quantizing error. Accordingly, it is desirable that the value α be set to approximately “2”.

If a rotation of the volume is detected once during AF:ON, the process passes through the processing of Step S420 which will be described below and the mode of focusing operation is set to AF:OFF. Accordingly, if the process again passes through the processing which starts from Step S501, the performance of subtle manual focusing is prevented from being impaired, owing to the processing of Step S502.

If it is determined in Step S504 that |Δ| is greater than or equal to the threshold k, the sign of difference Δ is checked in Step S410. From the sign of the difference Δ, it is possible to determine whether the value of the first memory R has increased or decreased from the previous value, so that it is possible to detect the direction in which the volume is rotated. In this embodiment, if the difference Δ is increasing, it is determined in Step S411 that the focusing lens should be driven toward the closest-distance position, whereas if the difference Δ is decreasing, it is determined in Step S412 that the focusing lens should be driven toward the ∞ position.

If the direction in which to drive the focusing lens is determined in Step S411 or S412, an amount in which to move the focusing lens according to the amount of rotation of the volume is calculated in Step S413. The computing expression for determining the amount fsp [pps] in which to drive the focusing lens per unit time in Step S413 is Expression (1) described previously, and the amount in which to drive the focusing lens per unit time is obtained from the computing expression.

In Step S414, it is determined that the volume is rotating, and the value of the rotation flag is set to “1”. In Step S415, the value of the memory R0 is replaced with the current value of the first memory R so that the value of the memory R0 can be compared with the value of the first memory R when the value of the counter N reaches “5”.

As described previously with reference to FIG. 12, the processing which starts from Step S416 is intended to enable a manual focusing operation to be executed even during the AF mode while the volume is rotating.

It is determined in Step S416 whether the volume is rotating. If it is determined that the volume is rotating, the value of the counter M is cleared to zero in Step S417 and the mode of operation is set to AF:OFF (Step S420). This process is brought to an end in Step S425 and the focusing lens is driven in the direction determined in Step S411 or S412. The counter M serves as a wait time counter for adding hysteresis when the mode of operation changes from AF:OFF to AF:ON, and is provided for preventing an AF operation from being performed during the rotation of the volume when the photographer nonuniformly rotates the volume.

If it is determined in Step S416 that the volume is not rotating, the state of the AF/MF selecting switch (the AF/MF selecting switch 222 shown in FIG. 9) is checked in Step S418. If the state of the AF/MF selecting switch 222 is the MF mode, it is determined that even if the volume is not rotating, the focusing lens does not need to move. Accordingly, the process proceeds to Step S419, in which the counter M is set to the predetermined value. In Step S420, the mode of operation is set to AF:OFF, and, in Step S425, the process is brought to an end.

If it is determined in Step S418 that the state of the AF/MF selecting switch 222 is the AF mode, it is determined that the AF mode is currently active and the volume is not rotating. The process proceeds to Step S421, in which it is determined whether the value of the counter M is greater than or equal to the predetermined value (in this embodiment, “30”).

If it is determined in Step S421 that the answer is false, the value of the counter M is incremented by one in Step S424, and the process is brought to an end in Step S425. If the process passes through Step S424, it indicates that the state of the AF/MF selecting switch 222 was the AF mode and the volume was rotated within the past thirty first sampling periods, and the mode of operation of the focusing lens is AF:OFF by the processing of Step S420. To check whether the rotation of the volume is actually stopped at this time, the mode of operation is not set to AF:ON within the predetermined time even if the value of the rotation flag is cleared to zero.

If it is determined in Step S421 that the rotation of the volume is continuously stopped for the predetermined time, the mode of operation is set to AF:ON in Step S422, and, in Step S423, a hill-climbing operation is executed by the AF processing routine to drive the focusing lens.

As is apparent from the above description, by varying the dead zone of detection of the rotation of the volume between AF:ON and AF:OFF and varying the sensitivity of detection of the rotation of the volume, even if the photographer mistakenly touches the volume during the AF mode, it is possible to prevent the focusing lens from malfunctioning, without impairing the performance of subtle focus adjustment required for manual focusing, and focusing can be performed only when the volume is substantially rotated.

Although the fourth embodiment has been described with reference to the endless type of volume-encoder, it is, of course, possible to carry out the fourth embodiment even in the case of a comb rotary type of encoder to be fitted into a lens barrel, such as the rotary type of encoder shown in FIGS. 14(a) and 14(b), by varying the sensitivity of detection of the amount of rotation of the volume.

In the case of a system which allows manual focusing to be performed through an manipulating member such as a push button, the sensitivity of detection of the amount of manipulation of the manipulating member may be varied according to the manipulating time of the manipulating member which is obtained by measuring the period of time during which the manipulating member is being pressed.

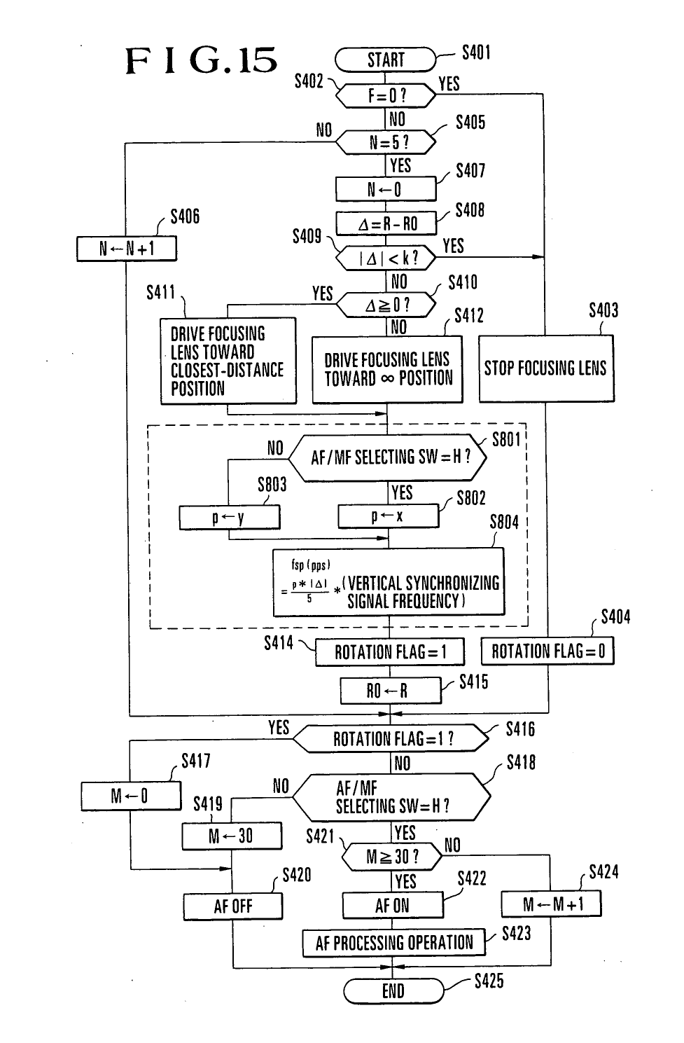

A fifth embodiment of the present invention will be described below with reference to the flowchart shown in FIG. 15. The fifth embodiment is intended for a lens control device which is adaptable to the intention of a photographer which rotates the volume.

Since the system construction of the fifth embodiment is similar to that of the fourth embodiment, the description thereof is omitted for the sake of simplicity.

The flowchart shown in FIG. 15, which is executed in the AF microcomputer 215, is a modified version of the above-described flowchart of FIG. 12 in that Steps S801 to S804 surrounded by dashed lines in FIG. 15 are added to the flowchart of FIG. 12. In FIG. 15, identical reference numerals are used to denote steps which correspond to the steps shown in FIG. 12, and the description thereof is omitted for the sake of simplicity.

The processing of Steps S801 to S804 is provided for varying the amount of movement of the focusing lens per unit amount of rotation of the volume (the amount of movement of the focusing with respect to the amount of rotation of the volume which varies during one vertical synchronizing period) between the AF mode and the MF mode, so that it is possible to rapidly move a focus toward a target subject during the AF mode, and, during the MF mode, smooth and subtle focusing of an intended subject can be achieved.

In Step S801, the state of the AF/MF selecting switch 222 of FIG. 9 is read, and it is determined whether the photographing mode set by the photographer is the AF mode or the MF mode.

If it is determined in Step S801 that the AF mode is set, the process proceeds to Step S802, in which the value of a memory p which is a response function of the amount of movement of the focusing lens per unit amount of rotation of the volume is replaced with a predetermined value x (the value p represents the amount of increase in the amount of driving of the focusing lens per variation of 1 LSB of Δ).

On the other hand, if it is determined in Step S801 that the MF mode is set, the process proceeds to Step S803, in which the value of the memory p is replaced with a predetermined value y.

In Step S804, the amount fsp of movement of the focusing lens per unit time is calculated from the above-described expression (1) by using the value of the response function p which has been determined in Step S802 or S803.

To realize rapid focusing during an automatic focusing operation and subtle focusing during a manual focusing operation as described previously, it is necessary that the predetermined values x and y satisfy x>y.

By performing the processing of Steps S801 to S804 in the above-described manner, it is possible to solve the problem that the photographer has to rotate over and again the volume for moving a focus during AF or is not able to perform subtle adjustment of focus during MF.

As is apparent from the above description, according to the fourth and fifth embodiments, since the response characteristic of the optical system relative to the manipulation of the manipulating means is varied according to the state of operation of the automatic focus controlling means, it is possible to optimize both the response characteristics of the optical system relative to the manipulation of the manipulating means which is manipulated while the automatic focus controlling means is operating and the response characteristics of the optical system relative to the manipulation of the manipulating means which is manipulated while the automatic focus controlling means is not operating, so that it is possible to realize optimum control of the driving of the focusing lens during both the automatic focusing mode and the manual focusing mode.

In addition, while the automatic focus controlling means is operating (during the AF mode), the movement of the optical system is inhibited if the amount of manipulation of ;the manipulating means is not greater than a predetermined amount, so that even when the photographer mistakenly touches the focus volume during the AF mode, the rotation of the volume is not detected and unnecessary defocusing is prevented from being induced by a malfunction of the focusing lens.

In addition, while the automatic focus controlling means is operating, the response of the optical system relative to a variation of the state of manipulation of the manipulating means is lowered, so that even when the photographer mistakenly touches the focus volume during the AF mode, the rotation of the volume is not detected and unnecessary defocusing is prevented from being induced by a malfunction of the focusing lens.

In addition, the detection sensitivity of the detecting means for detecting the state of manipulation of the manipulating means is varied according to the operational state of focus adjustment of the optical system, so that it is possible to optimize both the response characteristics of the optical system relative to the manipulation of the manipulating means which is manipulated while the automatic focus controlling means is operating and the response characteristics of the optical system relative to the manipulation of the manipulating means which is manipulated while the automatic focus controlling means is not operating, so that it is possible to realize optimum control of the driving of the focusing lens during both the automatic focusing mode and the manual focusing mode.

1. An image pickup apparatus having plural photographing program modes comprising:
mode selecting means for selecting one or more of said photographing program modes;
extracting means for extracting a focus signal corresponding to a degree of focus from a video signal;
focus detecting means for detecting a focus state of an object, on the basis of the focus signal outputted from said contracting means;
focusing means for performing a focusing adjusting operation according to an output of said focus detecting means; and
focus restarting means for restarting the focusing adjusting operation of said focusing means responsive to a selecting of the photographing program modes by said mode selecting means even if the focus state of the object is in-focus state.

2. An image pickup apparatus according to claim 1, wherein said focus detecting means determines whether the subject image is currently in focus, and, if the subject image is not in focus, determines whether the subject image is in near focus or far focus.

3. An image pickup apparatus according to claim 1, wherein said focusing means performs automatic focusing based on a hill-climbing method to make a level of the focus signal reach a maximum value.

4. (canceled)

5. An image pickup apparatus according to claim 1, wherein said focusing restarting means detects a level difference between a current AF evaluation value level and an AF evaluation value level obtained when the subject image is in focus, and restarts the focusing operation according to the level difference detected

6. An image pickup apparatus comprising:
focus controlling means for controlling an operation of driving means for moving a lens group for performing focus adjustment, in parallel with an optical axis;
image pickup mode selecting means for selecting one or more image pickup modes which are arbitrarily selectively usable according to image pickup conditions and have respective different automatic exposure characteristics;
state-of-image-pickup controlling means for performing control to provide an optimum state of image pickup for each of said one or more image pickup modes selected by said image pickup mode selecting means; and
focusing restarting means for restarting said focus controlling means in response to a selecting operation of the image pickup diodes by image pickup mode selecting means and for controlling said focusing controlling means and said state-of-image-pickup controlling means in an interlocking manner even if the focus state of the object is in-focus state.

7. An image pickup apparatus comprising:
a lens group for performing focus adjustment;
lens group driving means for moving said lens group;
sharpness extracting means for extracting in a sharpness signal corresponding to a degree of focus from a video signal generated by photoelectric conversion of a subject image inputted via said lens group;
focusing means for performing focus adjustment on the basis of the sharpness signal extracted by said sharpness extracting means;
image pickup mode selecting means for selecting one or more image pickup modes which have respective different automatic exposure characteristics;
controlling means for performing control to provide an optimum state of image pickup for each of said one or more image pickup modes selected by said image pickup mode selecting means; and
restarting means for forcedly restarting said lens group, even if a focus state is in-focus state, in response to a change of the image pickup mode is changed by said image pickup mode selecting means.

8. An image pickup apparatus according to claim 7, wherein even if the state of image pickup is varied by the control of said state-of-image-pickup controlling means, said focusing restarting means is inhibited from res said lens group, during a predetermined period of time.

9. An image pickup apparatus according to claim 8, wherein the predetermined period of time during which said focusing restarting means is inhibited from forcedly restarting said lens group is a period of time during which the state of image pickup is being varied by the control of said state-of-image-pickup controlling means.

10. An image pickup apparatus according to claim 7, wherein said state-of-image pickup controlling means provides the optimum state of image pickup by supposing one or more representative states of image pickup from among a state of exposure of a video signal a state of camera signal processing for performing gamma correction and aperture correction, a state of white balance, and a state of focus, and controlling one or more control parameters according to a condition corresponding to said one or more representative states.

11. A lens control device comprising:
an optical system the focus of which can be adjusted;
automatic focus controlling means for detecting a state of focus of said optical system and performing automatic focus adjustment;
manipulating means for manipulating said optical system in an arbitrary direction; and
controlling means for varying a response characteristic of said optical system relative to a manipulation of said manipulating means according to a state of operation of said automatic focus adjusting means.

12. A lens control device according to claim 11, wherein said controlling means is arranged to enable the manipulation of said manipulating means even while said automatic focus adjusting means is operating, and to inhibit a movement of said optical system if the amount of manipulation of said manipulating means is not greater than a predetermined amount, while said automatic focus adjusting means is operating.

13. A lens control device according to claim 11, wherein said controlling means is arranged to enable the manipulation of said manipulating means even while said automatic focus adjusting means is operating, and to lower a response of said optical system relative to a variation of a state of manipulation of said manipulating means while said automatic focus adjusting means is operating.

14. A lens control device comprising:
focus adjustment controlling means for automatically performing focus adjustment of au optical system;
manipulating means for performing focus adjustment of the optical system in accordance with an external manipulation;
detecting means for detecting a state of manipulation of said manipulating means;
lens controlling means for varying a state of the optical system according to a variation of the state of manipulation of said manipulating means which is detected by said detecting means; and
controlling means for varying a detection sensitivity of said detecting means according to an operational state of focus adjustment of the optical system.

15. A lens control device according to claim 14, wherein said controlling means performs control to lower the detection sensitivity of said detecting means while said focus adjustment controlling means is operating.

16. A lens control device according to claim 15, further comprising selecting means for selecting permission or inhibition of execution of the focus adjustment by said focus adjustment controlling means, said controlling means controlling the detection sensitivity of said detecting means according to a selecting operation of said selecting means.

17. A lens control device comprising:
focus adjustment controlling means for automatically performing focus adjustment of an optical system;
manipulating means for performing focus adjustment of the optical system in accordance with an external manipulation;
detecting means for detecting a state of manipulation of said manipulating means;
lens controlling means for varying a state of the optical system according to a variation of the state of manipulation of said manipulating means which is detected by said detecting means; and
controlling means for varying a ratio of variation of the state of the optical system with respect to a ratio of variation of the state of manipulation of said manipulating means in said lens controlling means, according to an operational state of said focus adjustment controlling means.

18. A lens control device according to claim 17, further comprising selecting means for selecting permission or inhibition of execution of the focus adjustment by said focus adjustment controlling means, said controlling means varying the ratio of variation of the state of the optical system with respect to the ratio of variation of the state of manipulation of said manipulating means in said lens controlling means, according to a selecting operation of said selecting means.

19. An image pickup apparatus having a plurality of image pickup modes having respective different automatic exposure characteristics, comprising:
mode selecting means for selecting one or more of said image pickup modes;
focus detecting means for detecting a focus state;
focus control means for performing a focusing operation on the basis of an output of said focus detecting means; and
control means for, even if the focus state is in-focus state, restarting the focusing operation by said focus control means in response to a selecting operation of the image pickup modes by mode selecting means.

20. An apparatus according to claim 19, wherein said image pickup modes are program modes.

21. An apparatus according to claim 20, wherein said control means restarts the focusing operation after the program mode is changed.

22. An apparatus according to claim 19, wherein said control means determines whether the subject image is currently in focus, and, if the subject image is not in focus, determines whether the subject image is in near focus or far focus.

23. An image pickup apparatus according to claim 19, wherein said control means performs automatic focusing based on a hill-climbing method to make a level of the output of said focus detecting circuit reach a maximum value.

24. An image pickup apparatus according to claim 19, wherein said control means detects a level difference between a current AF evaluation value level obtained when the subject image is in focus, and restarts the focusing operation according to the level difference detected.
